(19) United States
(12) Patent Application Publication
(10) Pub. No.: US 2025/0002658 A1
(43) Pub. Date: Jan. 2, 2025

(54) LIGNOCELLULOSIC BIOMASS PROCESSING UTILIZING HYDROPHOBIC DEEP EUTECTIC SOLVENTS

(71) Applicant: University of Kentucky Research Foundation, Lexington, KY (US)

(72) Inventors: Jian Shi, Lexington, KY (US); Yuxuan Zhang, Lexington, KY (US)

(21) Appl. No.: 18/760,475

(22) Filed: Jul. 1, 2024

Related U.S. Application Data
(60) Provisional application No. 63/524,334, filed on Jun. 30, 2023.

(51) Int. Cl. C08H 8/00; C08B 15/00; C08H 7/00; C13K 1/04

(52) U.S. Cl. CPC C08H 8/00; C08B 15/00; C08H 6/00; C13K 1/04

(57) ABSTRACT

Methods for processing a lignocellulosic biomass are provided and include the steps of: combining the lignocellulosic biomass with a hydrophobic deep eutectic solvent (HDES); heating a mixture including the lignocellulosic biomass and the HDES; and separating the mixture into a HDES phase including a first constituent of the lignocellulosic biomass, an aqueous phase including a second constituent of the lignocellulosic biomass, and a solid-residue phase including a third constituent of the lignocellulosic biomass. Water is added to the combination of the lignocellulosic biomass and the HDES, either before or after heating. An acidic additive can be added prior to heating the mixture including the lignocellulosic biomass and the HDES, or a ternary HDES including an acidic compound can be utilized, to further promote dissolution of the lignocellulosic biomass prior to heating.

### RELATED APPLICATIONS

The present application claims priority to U.S. Patent Application Ser. No. 63/524,334, filed on Jun. 30, 2023, the entire disclosure of which is incorporated herein by reference.

### GOVERNMENT INTEREST

This invention was made with government support under grant number 1015068 awarded by the National Institute of Food and Agriculture. The government has certain rights in the invention.

### TECHNICAL FIELD

The presently disclosed subject matter relates to methods for processing lignocellulosic biomasses. In particular, embodiments of the presently disclosed subject matter relate to methods for processing lignocellulosic biomasses in which a hydrophobic deep eutectic solvent is utilized to promote fractionation of the biomass into recoverable constituents.

### BACKGROUND

To reduce greenhouse gasses, the world is enacting a transformation of its energy system from one dominated by fossil fuel combustion to one with much lower emissions. In 2020, the industrial sector accounted for about 33% of the nation's energy use, with the pulp and paper industry being one of the largest energy users, about 6.2% of the US industrial energy use.

Lignocellulosic biomasses are plant matter rich in lignin, cellulose, and hemicellulose. Due to its availability and renewability, lignocellulosic biomasses can be utilized as feedstock in biofuel production and certain industrial applications. In some instances, it is desirable to fractionate lignocellulosic biomass so that its lignin, cellulose, or hemicellulose can be isolated and subsequently utilized in the manufacture of commercial goods or further processed to extract valuable compounds. For instance, in the pulp and paper manufacturing industry, where fibrous cellulose is processed into pulp that is subsequently treated to produce paper, it is necessary to separate lignin and hemicellulose within a lignocellulosic biomass from its cellulose. As disclosed in commonly assigned U.S. Pat. No. 10,723,859, which is incorporated herein in its entirety by reference, isolated lignin can be processed to produce valorized compounds which may help improve the economic viability of biofuel production.

Deep eutectic solvents (DESs) are homogenous mixtures which are formed by mixing and heating a hydrogen bond donor (HBD) and a hydrogen bond acceptor (HBA) until a homogenous liquid is formed, and which have a lower melting point than its constituents. The properties of DESs can be tailored by adjusting the ratio HBD and HBA and/or by the acidities of the HBD and HBA utilized. DESs are non-toxic, exhibit low vapor pressure, and can be easily prepared with high purity and low costs as compared to ionic liquids. As such, DESs have emerged as a viable and environmentally friendly alternative to toxic and volatile organic solvents. DESs can be hydrophilic or hydrophobic. Due to their affinity to water, hydrophilic DESs may efficiently penetrate biomass cell walls which are rich in water, hydrolyze glycosidic bonds in hemicellulose and ester bonds between hemicellulose and lignin, and facilitate fiber swelling within a lignocellulosic biomass resulting in improved penetration and delignification of the biomass. At the same time, however, such affinity may diminish the solvation power of hydrophilic DESs due to environmental moisture absorption and make recovery of the hydrophilic DESs and constituents of lignocellulosic biomasses fractionated thereby more difficult due to the dispersion of such DESs.

Accordingly, alternative methods for processing lignocellulosic biomasses that utilize alternative solvents which facilitate fractionation of a lignocellulosic biomass and reduce the difficulty of solvent and lignocellulosic constituent recovery would thus be beneficial and desirable.

### SUMMARY

The presently disclosed subject matter meets some or all of the above-identified needs, as will become evident to those of ordinary skill in the art after a study of information provided in this document.

This summary describes several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

The presently disclosed subject matter includes methods for processing a lignocellulosic biomass. In particular, certain embodiments of the presently disclosed subject matter includes methods for processing a lignocellulosic biomass in which a hydrophobic deep eutectic solvent (HDES) is utilized to fractionate the lignocellulosic biomass into recoverable constituents. Specifically, in the methods of the present disclosure, a HDES is combined with a lignocellulosic biomass and the resulting mixture is subsequently heated to promote dissolution of the lignocellulosic biomass.

In some embodiments a method for processing a lignocellulosic biomass comprises: combining the lignocellulosic biomass with a HDES and water; heating a mixture including the lignocellulosic biomass, the HDES and the water at a predetermined temperature for a predetermined period of time; and separating the mixture into a HDES phase, an aqueous phase, and a solid-residue phase. The HDES phase includes the HDES and a first constituent of the lignocellulosic biomass. The aqueous phase includes the water and a second constituent of the lignocellulosic biomass. The solid-residue phase includes a third constituent of the lignocellulosic biomass. In some embodiments, the first lignocellulosic constituent is lignin. In some embodiments, the second constituent of the lignocellulosic biomass is hemicellulose or a derivative thereof. In some embodiments, the third lignocellulosic biomass is a glucan. In some embodiments, the predetermined period of time is at least one hour and the predetermined temperature is about 120° C. to about 140° C. In some embodiments, the lignocellulosic biomass is wheat straw or poplar wood.

In some embodiments, separating the mixture includes: filtering the mixture to isolate a liquid fraction and a solid fraction, wherein the liquid fraction includes the HDES phase and the aqueous phase, and the solid fraction includes the solid-residue phase; centrifuging the liquid fraction to separate the HDES phase and the aqueous phase in the liquid fraction; and isolating the HDES phase from the aqueous phase. In some embodiments, separating the mixture includes allowing, following the predetermined period of time in which the mixture is heated, time for the mixture to separate into the HDES phase, the aqueous phase, and the solid-residue phase as a result of the hydrophobicity of the HDES phase and the density of the solid-residue phase.

In some embodiments, an additive is added to the mixture prior to the mixture being heated. In some embodiments, an acidic additive is added to the mixture prior to the mixture being heated. In some embodiments, the acidic additive is malic acid, acetic acid, sulfuric acid, or aluminum chloride. In some embodiments, the acidic additive is about 0.5 wt % to about 3.0 wt % of the mixture. In some embodiments, a basic additive is added to the mixture prior to the mixture being heated. In some embodiments, the basic additive is sodium hydroxide. In some embodiments, the basic additive is about 1.0 wt % of the mixture.

In some embodiments, the method further includes: precipitating the first constituent of the lignocellulosic biomass in the HDES phase by adding an anti-solvent to the HDES phase; and isolating the first constituent precipitate of the lignocellulosic biomass from the HDES. In some embodiments, the method further includes isolating the HDES from the anti-solvent; and combining the isolated HDES with a second lignocellulosic biomass. In some embodiments, the anti-solvent is 2-methyl tetrahydrofuran, dimethyl ether, methyl acetate, and ethyl acetate.

In some embodiments, the HDES is a binary HDES formed utilizing two compounds. In some embodiments, the HDES is a ternary HDES formed utilizing three compounds. In some embodiments, the HDES includes thymol and 2,6-dimethoxy phenol. In some embodiments, the HDES is: menthol: 2,6-dimethoxyphenol (1:1); menthol: 2,6-dimethoxyphenol (1:2); menthol: 2,6-dimethoxyphenol (2:1); menthol:phenol (1:1); menthol:phenol (1:2); menthol:phenol (2:1); menthol: 1-phenylethanol (1:1); menthol:guaiacol (1:1); thymol:vanillin (1:1); thymol:2,6-dimethoxyphenol (1:1); thymol:2,6-dimethoxyphenol (1:2); thymol:2,6-dimethoxyphenol (2:1); thymol:phenol (1:1); thymol:phenol (1:2); thymol:phenol (2:1); decanoic acid:2,6-dimethoxyphenol (1:1); decanoic acid:2,6-dimethoxyphenol (1:2); decanoic acid:2,6-dimethoxyphenol (2:1); decanoic acid:phenol (1:1); decanoic acid:phenol (1:2); decanoic acid:phenol (2:1); decanoic acid:guaiacol (1:1); decanoic acid: 1-phenylethanol (1:1); 2,6-dimethoxyphenol:4-hydroxybenzyl alcohol (1:1); 2,6-dimethoxyphenol:4-hydroxybenzyl alcohol (2:1); 2,6-dimethoxyphenol:4-hydroxybenzyl alcohol (3:1); 2,6-dimethoxyphenol:4-hydroxybenzyl alcohol (4:1); 2,6-dimethoxyphenol:4-hydroxybenzyl alcohol (5:1); 2,6-dimethoxyphenol:vanillin (1:1); 2,6-dimethoxyphenol:vanillin (2:1); 2,6-dimethoxyphenol:phenol (1:1); 2,6-dimethoxyphenol:phenol (1:2); 2,6-dimethoxyphenol:phenol (2:1); thymol:2,6-dimethoxyphenol:o-anisic acid (2:2:1); thymol:2,6-dimethoxyphenol:decanoic acid (2:1:1); thymol:2,6-dimethoxyphenol:syringic acid (5:5:1); or thymol:2,6-dimethoxyphenol:vanillic acid (5:5:1).

In some embodiments, a method for processing a lignocellulosic biomass comprises: combining the lignocellulosic biomass with a HDES; heating a mixture including the lignocellulosic biomass and the HDES and the water at a predetermined temperature for a predetermined period of time; adding water to the mixture after the predetermined period; and separating the mixture, following the addition of water, into a HDES phase, an aqueous phase, and a solid-residue phase.

In some embodiments, a method for processing a lignocellulosic biomass comprises: combining the lignocellulosic biomass with a hydrophobic deep eutectic solvent (HDES), water, and an acidic additive to form a mixture; heating the mixture, after a first predetermined period of time following formation of the mixture, for a second predetermined period of time; and separating the mixture into a HDES phase including the HDES and lignin, an aqueous phase including the water and a hemicellulose or a derivative thereof, and a solid-residue phase including a glucan.

### BRIEF DESCRIPTION OF THE DRAWINGS

The presently-disclosed subject matter will be better understood, and features, aspects and advantages other than those set forth above will become apparent when consideration is given to the following detailed description thereof. Such detailed description makes reference to the following drawings, wherein:

FIG. 1 is a schematic diagram showing an exemplary method for processing a lignocellulosic biomass in accordance with the present disclosure

FIG. 2 is a flow chart of the exemplary method of FIG. 1;

FIG. 3 is a schematic diagram showing another exemplary method for processing a lignocellulosic biomass in accordance with the present disclosure;

FIG. 4 is a flow chart of the exemplary method of FIG. 3; and

FIGS. 5A-5D are images showing the treatment of pinewood ((A) and (B)) and kraft lignin ((C) and (D)) with a Thymol (Thy): 2,6-dimethoxyphenol (Dmp) (1:1) HDES. (A) HDES and pinewood before pulping at 140° C. for two hours. (B) HDES and pinewood after pulping 140° C. for two hours and application of ethyl acetate anti-solvent. (C) HDES and kraft lignin after pulping at 80° C. for one-half hour. (D) HDES and kraft lignin after application of ethyl acetate anti-solvent.

FIGS. 6A-6B are graphs illustrating the retention rates of glucan and removal rates of xylan and lignin for (A) wheat straw and (B) poplar wood under various pretreatments. Thy:Dmp11 indicates use of thymol:2,6-dimethoxyphenol (1:1). Glucan retention=left bar, xylan removal=middle bar, and lignin removal=right bar.

FIGS. 7A-7H are scanning electron microscope (SEM) images of: untreated wheat straw at a magnification of (A) 500× and (C) 2500×; Thy:Dmp (1:1)-AlCl₃ treated wheat straw at (B) 500× and (D) 2500×; untreated poplar wood at a magnification of (E) 500× and (G) 2500×; and Thy:Dmp (1:1)-AlCl₃ treated poplar wood at (F) 500× and (H) 2500×.

FIGS. 8A-8B are graphs illustrating Fourier Transform Infrared Spectrometry (FTIR) spectra of biomass before and after Thy:Dmp (1:1)-AlCl₃ pretreatment for (A) wheat straw and (B) poplar wood. Raw=upper line and pretreated=lower line.

FIGS. 9A-9B are graphs illustrating x-ray diffraction analysis (XRD) patterns of untreated and pretreated (Thy:Dmp (1:1)-AlCl₃) (A) wheat straw and (B) poplar wood with their corresponding CrI values. Raw=upper line (except where cross-over occurs in FIG. 9A) and pretreated=lower line.

FIG. 10 is a graph illustrating glucose yield from enzymatic hydrolysis of solids before and after Thy:Dmp (1:1)-AlCl₃ pretreatment. Left bar=whet straw and right bar=poplar wood.

FIG. 11 is a graph and table illustrating the molecular weight distributions of Thy:Dmp (1:1)-AlCl₃ precipitated lignin (HDES-L) and enzymatic mild acidolysis lignin (EMAL) from wheat straw and poplar wood.

FIGS. 12A-12D are graphs illustrating two-dimension heteronuclear single quantum coherence nuclear magnetic resonance (2D HSQC NMR) spectra of lignin structural subunits and side chains for (A) EMAL from wheat straw, (B) Thy:Dmp (1:1)-AlCl₃ HDES-L treated with from wheat straw, (C) EMAL from poplar wood, and (D) Thy:Dmp (1:1)-AlCl₃ HDES-L from poplar wood.

FIG. 13 is a graph illustrating a representative high-performance liquid chromatography (HPLC) chromatogram of the aqueous phase of Thy:Dmp (1:1)-AlCl₃ pretreatment.

FIG. 14 is a graph illustrating a representative gas chromatography-mass spectrometry (GC-MS) chromatogram of recovered ethyl acetate and Thy:Dmp (1:1). Ethyl acetate=upper line and HDES=lower line.

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Unless defined otherwise, all technical and scientific terms used herein have the same meaning as commonly understood by one of ordinary skill in the art to which the disclosure belongs.

The present application can “comprise” (open ended), “consist of” (closed ended), or “consist essentially of” the components of the present disclosure as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a,” “an,” and “the” refer to “one or more” when used in this application, including the claims. Thus, for example, reference to “a cell” includes a plurality of cells, and so forth.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration, percentage, or the like is meant to encompass variations of in some embodiments ±50%, in some embodiments ±40%, in some embodiments ±30%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Where reference is made to a URL or other such identifier or address, it is understood that such identifiers can change and particular information on the internet can come and go, but equivalent information can be found by searching the internet. Reference thereto evidences the availability and public dissemination of such information.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, ElZ specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used herein, “optional” or “optionally” means that the subsequently described event or circumstance does or does not occur and that the description includes instances where said event or circumstance occurs and instances where it does not. For example, an optional ingredient means that the ingredient can be included or cannot.

All combinations of method or process steps referred to herein can be performed in any order, unless otherwise specified or clearly implied to the contrary by the context in which the referenced combination is made.

As used herein, the term “lignocellulosic biomass” means plant matter which is mainly composed of cellulose, hemicellulose, and lignin. In some embodiments, the composition of the lignocellulosic biomass utilized in the methods disclosed herein may be about 5% to about 80% cellulose, about 10% to about 50% hemicellulose, and about 5% to about 40% lignin.

It should be appreciated that in instances where reference is made to multiple items being in a specified ratio (e.g., molar ratio, volume ratio, weight ratio, etc.) the order of the numerical values within the specified ratio corresponds to the order in which the respective items referred to in connection with the ratio are recited. For instance, where reference is made to a HDES including thymol and 2,6-dimethoxyphenol in a molar ratio of 1:2, the HDES includes one mole of thymol and two moles of 2,6-dimethoxyphenol.

The presently-disclosed subject matter includes methods for processing lignocellulosic biomasses. In particular, the presently disclosed subject matter includes methods for processing a lignocellulosic biomass in which a hydrophobic deep eutectic solvent (HDES) is utilized to fractionate the lignocellulosic biomass into recoverable constituents. Specifically, in the methods of the present disclosure, a HDES is combined with a lignocellulosic biomass and the resulting mixture is subsequently heated to promote dissolution of the lignocellulosic biomass. With respect to dissolution of the lignocellulosic biomass, the functional groups (e.g. hydroxyl and carboxyl groups) of the HDES constituents and the hydrogen bonding network within the DES system can interact with ether bonds between lignin and ether/ester bonds between carbohydrates and lignin in lignin-carbohydrate complex (LCC), leading to the cleavage of these bonds. As a result, the linkage between the biomass constituents is broken and lignin can be dissolved and extracted from the biomass matrix. During dissolution, lignin is dissolved in the HDES and disassociated from the carbohydrate-rich constituents of the lignocellulosic biomass (i.e., cellulose and hemicellulose). To further promote dissolution of the lignocellulosic biomass, in some embodiments, one or more additives, such as one or more acidic additives, may optionally be added to, and thus form part of, the mixture prior to heating. The additives can further improve the cleavage of covalent bonds that link lignin with hemicellulose and cellulose. Additionally, the additives can facilitate the depolymerization of hemicellulose. As a result, the fractionation of the biomass is improved. Separation of the lignin-infused HDES and the cellulose-rich constituents, is facilitated by the addition of water to the mixture. As will become evident in the discussion which follows, embodiments in which water is added to, and thus forms part of, the mixture including the HDES and the lignocellulosic biomass prior to heating, as well as embodiments in which water is added to the mixture after heating, are contemplated herein.

Due to the hydrophobic nature of the HDES, the lignin-infused HDES segregates from the water, thus prompting the development of a system with three phases: a HDES phase including the HDES and dissolved lignin; a water (or aqueous) phase, including water-soluble constituents of the lignocellulosic biomass, such as hemicellulose constituents and/or derivatives thereof, such as sugars (e.g., xylose) derived from the depolymerization of hemicellulose constituents (e.g., xylan); and a solid-residue phase which includes cellulose-rich constituents of the lignocelluosic biomass (e.g., glucan). In lignincellulosic biomass processing applications utilizing hydrophilic deep eutectic solvents (DESs), the hydrophilic DES including dissolved lignin is not segregated from the cellulose-rich material of the lignocellulosic biomass due to the dispersion of the DES as a result of its hydrophilic nature. Rather, the application of a thinning agent is typically required to separate the hydrophilic DES from the cellulose of the lignocellulosic biomass and the hydrophilic DES must be purified. Currently, there is no effective method to disassociate the hemicellulose of the lignocellulosic biomass from the hydrophilic DES. The direct phase separation of the lignin-infused HDES from the water and cellulose-rich material in the methods of the present disclosure is thus advantageous as it reduces the number of steps required to recover cellulose-rich materials derived from fractionated lignocellulosic biomass and facilitates simpler solvent recovery as compared to processing methods utilizing hydrophilic DESs. With respect to the latter advantage, in some embodiments of the methods disclosed herein, lignin is precipitated from the HDES by introducing one or more anti-solvents to the HDES phase and subsequently recovered. As a result of the hydrophobic nature and the direct phase separation of the HDES phase and the cellulose-rich material, the amount of anti-solvent loading required to precipitate the lignin is significantly reduced relative to that required in hydrophilic DES systems, which, in turn, can serve to reduce equipment size, distillation energy consumption, and waste generation.

After the precipitation of lignin, in some embodiments of the methods disclosed herein, lignin is recovered from the HDES phase, e.g., via filtration or centrifuging and decanting. The HDES separated from the lignin precipitate is then, in some embodiments of the methods disclosed herein, recycled and combined with additional lignocellulosic biomasses to facilitate the fractionation thereof. Prior to recycling the HDES, the anti-solvent is, in some embodiments of the methods disclosed herein, removed, e.g., via evaporation or distillation, and reused for subsequent lignin precipitation. As a result of the hydrophobic nature and the direct phase separation of the HDES phase and the cellulose-rich material, the amount of anti-solvent loading required to precipitate the lignin will typically be significantly reduced relative to that required in hydrophilic DES systems, which, in turn, can serve to reduce equipment size, distillation energy consumption, and waste generation.

Water or a mixture of ethanol and water is commonly utilized as an anti-solvent to precipitate lignin from eutectic solvents. Certain embodiments of the methods disclosed herein utilize alternative anti-solvents which may also serve to reduce the amount of anti-solvent loading and distillation energy required to recover lignin from fractionated lignocellulosic biomasses.

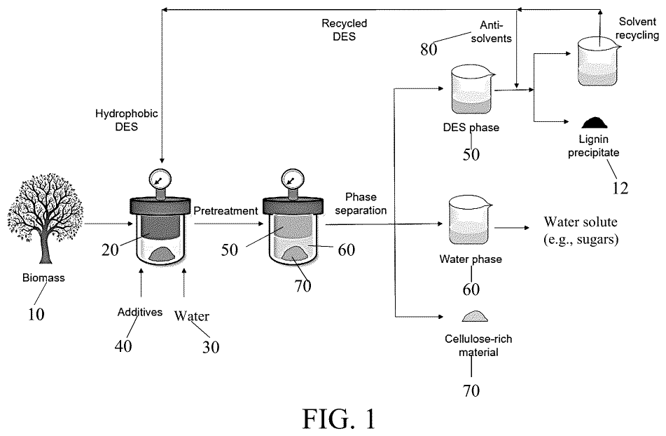

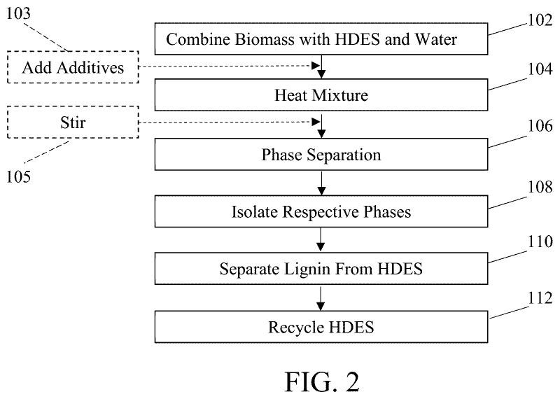

FIGS. 1 and 2 show certain steps of an exemplary method for processing lignocellulosic biomasses.

Referring now to FIGS. 1 and 2, in this exemplary embodiment, the method commences by combining a lignocellulosic biomass 10, a HDES 20, and water 30, as indicated by block 102 in FIG. 2. In some embodiments, the lignocellulosic biomass 10 and HDES 20 may be combined in a weight ratio of about 1:5 w/w to about 1:50 w/w. In some embodiments, the lignocellulosic biomass 10 and HDES 20 may be combined in a weight ratio of about 1:10. In some embodiments, the weight ratio of the HDES 20 to water 30 is about 0.1:1 w/w to about 10:1 w/w. In some embodiments, the weight ratio of the HDES 20 to water 30 is 1:1 w/w. The mixture including the lignocellulosic biomass 10, the HDES 20, and the water 30 is subsequently heated at a predetermined temperature for a predetermined period of time to promote dissolution of the lignocellulosic biomass 10, as indicated by block 104 in FIG. 2. In some embodiments, the predetermined temperature is about 80° C. to about 200° C. In some embodiments, the predetermined temperature is about 120° C. to about 140° C. In some embodiments the predetermined temperature is 120° C. In some embodiments the predetermined temperature is 140° C. In some embodiments, the predetermined time for heating the mixture ranges from about one minute to about 24 hours. In some embodiments, the predetermined period for heating is at least one hour. In some embodiments, the predetermined period for heating is about two hours. In some embodiments, the predetermined period for heating is about three hours. In some embodiments, the lignocellulosic biomass 10 is soaked in the HDES 20, HDES 20 and water 30, or HDES 20, water 30, and additive 40 for a predetermined period prior to being heated. In some embodiments, the lignocellulosic biomass 10 may be soaked in the HDES 20, HDES 20 and water 30, or HDES 20, water 30, and additive 40 for a period ranging from about one hour to about 72 hours prior to being heated. In some embodiments, the lignocellulosic biomass 10 may be soaked in the HDES 20, HDES 20 and water 30, or HDES 20, water 30, and additive 40 for about eight hours prior to being heated.

As lignocellulosic biomasses are mainly composed of the constituents of aromatic-rich polymer lignin and two carbohydrate polymers-cellulose and hemicellulose, the chemical decomposition of different lignocellulosic biomasses into the foregoing constituents is similar, and as such, may be similarly fractionated by the various HDESs disclosed herein. The functional groups (e.g. hydroxyl and carboxyl groups) of the HDES constituents and the hydrogen bonding network within the DES system can interact with ether bonds between lignin and ether/ester bonds between carbohydrates and lignin in lignin-carbohydrate complex (LCC), leading to the cleavage of these bonds. As a result, the linkage between the lignocellulosic biomass constituents is broken and lignin can be dissolved and extracted by the HDES from the biomass matrix. Additionally, hemicellulose depolymerizes into oligo- and mono-saccharides that are soluble in water, and thus, can be removed using water. Accordingly, lignocellulosic biomasses which may be processed in the exemplary method include, but are not limited to: wheat straw; rice straw; barley straw; rye straw; oat straw; rice husk; sugarcane bagasse; sweet sorghum bagasse; corn stover; corn leaves; bamboo; switchgrass; hazelnut shell; miscanthus; and hardwood biomasses, such as beech wood, poplar wood, aspen wood, cherry wood, willow wood, pine wood, spruce wood, P. armandii franch, Japanese cedar wood, and fir wood.

In some embodiments, the HDES utilized in the exemplary method is a binary HDES (i.e., a HDES formed using two compounds). Binary HDESs suitable for use in the exemplary method include those synthesized by mixing and heating the compounds in the molar ratios specified in TABLE 1 below until a homogenous eutectic mixture is formed. Accordingly, in some embodiments, the HDES 20 is one of the HDEs listed in TABLE 1. In some embodiments, the HDESs may be synthesized in the same or similar manner as disclosed in U.S. Patent Application Publication No. 2022/0144669, which is incorporated herein by reference in its entirety. In some embodiments, the HDES 20 is Thymol: 2,6-dimethoxyphenol (1:1). In some embodiments, the HDES 20 is Thymol: 2,6-dimethoxyphenol (1:2). In some embodiments, the HDES 20 is Thymol: 2,6-dimethoxyphenol (2:1). Each of the HDESs listed in TABLE 1 have been found to exhibit good solubility for lignin. Thus, while the methods of the present disclosure are sometimes described herein as employing a specific one of the HDESs listed in TABLE 1, it is believed, without wishing to be bound by any particular theory, that the other binary HDESs listed in TABLE 1—either alone or with the aid of one or more of the additives (e.g., an acidic additive) described herein-could be similarly employed and be effective, at least to some degree, in promoting the fractionation of a lignocellulosic biomass.

TABLE 1
Binary hydrophobic deep eutectic solvents (HDESs).

| | | | Molar Ratio |
|---|---|---|---|
| | | | (Compound A: |
| HDES | Compound A | Compound B | Compound B) |
| 1 | Menthol | 2,6-dimethoxyphenol | 1:1 |
| 2 | Menthol | 2,6-dimethoxyphenol | 1:2 |
| 3 | Menthol | 2,6-dimethoxyphenol | 2:1 |
| 4 | Menthol | phenol | 1:1 |
| 5 | Menthol | phenol | 1:2 |
| 6 | Menthol | phenol | 2:1 |
| 7 | Menthol | 1-phenylethanol | 1:1 |
| 8 | Menthol | guaiacol | 1:1 |
| 9 | Thymol | vanillin | 1:1 |
| 10 | Thymol | 2,6-dimethoxyphenol | 1:1 |
| 11 | Thymol | 2,6-dimethoxyphenol | 1:2 |
| 12 | Thymol | 2,6-dimethoxyphenol | 2:1 |
| 13 | Thymol | phenol | 1:1 |
| 14 | Thymol | phenol | 1:2 |
| 15 | Thymol | phenol | 2:1 |
| 16 | Thymol | guaiacol | 1:1 |
| 17 | Decanoic acid | 2,6-dimethoxyphenol | 1:1 |
| 18 | Decanoic acid | 2,6-dimethoxyphenol | 1:2 |
| 19 | Decanoic acid | 2,6-dimethoxyphenol | 2:1 |
| 20 | Decanoic acid | phenol | 1:1 |
| 21 | Decanoic acid | phenol | 1:2 |
| 22 | Decanoic acid | phenol | 2:1 |
| 23 | Decanoic acid | guaiacol | 1:1 |
| 24 | Decanoic acid | 1-phenylethanol | 1:1 |
| 25 | 2,6-dimethoxyphenol | 4-hydroxybenzyl | 1:1 |
| | | alcohol | |
| 26 | 2,6-dimethoxyphenol | 4-hydroxybenzyl | 2:1 |
| | | alcohol | |
| 27 | 2,6-dimethoxyphenol | 4-hydroxybenzyl | 3:1 |
| | | alcohol | |
| 28 | 2,6-dimethoxyphenol | 4-hydroxybenzyl | 4:1 |
| | | alcohol | |
| 29 | 2,6-dimethoxyphenol | 4-hydroxybenzyl | 5:1 |
| | | alcohol | |
| 30 | 2,6-dimethoxyphenol | vanillin | 1:1 |
| 31 | 2,6-dimethoxyphenol | vanillin | 2:1 |
| 32 | 2,6-dimethoxyphenol | phenol | 1:1 |
| 33 | 2,6-dimethoxyphenol | phenol | 1:2 |
| 34 | 2,6-dimethoxyphenol | phenol | 2:1 |

Referring now again to FIGS. 1 and 2, as shown, in some embodiments, an additive 40 may be added to the mixture including the lignocellulosic biomass 10, HDES 20, and water 30 prior to or during heating to further promote dissolution of the lignocellulosic biomass 10, as indicated by block 103 in FIG. 2. Additives, and, in particular, acidic additives, can further improve the cleavage of covalent bonds that link lignin with hemicellulose and cellulose, promoting the dissolution of lignin in DES. Additionally, the inclusion of additives, such as an acidic additive, can facilitate the depolymerization of hemicellulose (e.g., xylan) into oligo- and mono-saccharide (e.g., xylose) that are soluble in water. As a result, the dissolution of the biomass is improved. In such embodiments, the additive 40 may thus be considered as constituting part of the mixture subjected to heating. In some embodiments, the additive 40 comprises about 0.5 wt % to about 3 wt % of the mixture subjected to heating. In some embodiments, the additive 40 may include multiple additives. In some embodiments, the additive 40 is acidic. In some embodiments, the additive 40 is one or more of sulfuric acid, aluminum chloride, acetic acid, and malic acid. In some embodiments the additive 40 is basic. In some embodiments, the additive 40 includes one or more of sodium hydroxide and potassium hydroxide. In some embodiments, the additive 40 is one or more metal salts. In some embodiments, the additive 40 includes one or more of aluminum chloride, iron (iii) chloride, and aluminum sulfate. In some embodiments, the additive 40 is a combination of at least two of one or more acids, one or more bases, and one or more metal salts. In some embodiments, the mixture may be stirred during heating, as indicated in block 105 in FIG. 2. It is appreciated that in the figures of the present application, blocks illustrated in broken lines refer to optional steps which may be carried out in some embodiments of the methods disclosed herein.

As further discussed in the examples below, it has surprisingly been found that the improved fractionation of lignocellulosic biomasses facilitated by the use of an acidic additive can also be realized by utilizing HDESs which include an acidic component therein. Thus, in some embodiments, the HDES utilized is a ternary HDES (i.e., a HDES formed utilizing three compounds), which includes an acidic compound that promotes cleavage of covalent bonds that link lignin with hemicellulose and cellulose and facilitates the depolymerization of hemicellulose. In this regard, the use of a ternary HDES including an acidic compound may serve to eliminate the need for the use of an acidic additive, and thus any challenges associated with the subsequent recovery and recycling thereof and time and costs associated therewith, while still providing improved fractionation of the lignocelluosic biomass. Ternary HDESs which may be utilized in the methods disclosed herein can be formed by adding an acidic compound to a binary HDES disclosed herein. Various fatty acids, including, but not limited to, decanoic acid, butyric acid, and dodecanoic acid, can, in some embodiments, be utilized as such acidic compound. Various aromatic acids, including, but not limited to, 4-hydroxybenzoic acid, gallic acid, ferulic acid, vanillic acid, anisic acid, 3,4-dimethoxybenzoic acid, 3,4,5-trimethoxybenzoic acid, and toluic acid, can, in some embodiments, be utilized as such acidic compound. Ternary HDESs suitable for use in the exemplary method thus include those synthesized by mixing and heating the compounds in the molar ratios specified in TABLE 2 below until a homogenous eutectic mixture is formed.

TABLE 2
Ternary hydrophobic deep eutectic solvents (HDESs).

| | | | | Molar Ratio |
|---|---|---|---|---|
| | | | | (Compound A: |
| | Compound | | Compound | Compound B: |
| HDES | A | Compound B | C | Compound C) |
| 1 | Thymol | 2,6- | o-anisic | 2:2:1 |
| | | dimethoxyphenol | acid | |
| 2 | Thymol | 2,6- | Decanoic | 2:1:1 |
| | | dimethoxyphenol | acid | |
| 3 | Thymol | 2,6- | Syringic | 5:5:1 |
| | | dimethoxyphenol | acid | |
| 4 | Thymol | 2,6- | Vanillic | 5:5:1 |
| | | dimethoxyphenol | acid | |

Referring still to FIGS. 1 and 2, following the predetermined period of heating, the mixture may, in some embodiments, be allowed to naturally separate into three distinct phases: (i) a HDES phase 50, including the HDES 20 and a first constituent of the lignocellulosic biomass 10; (ii) a water (aqueous) phase 60, including the water 30 and a second constituent of the lignocellulosic biomass 10; and (iii) a solid-residue phase 70, including a third constituent of the lignocellulosic biomass 10 as a result of the hydrophobicity of the HDES phase 50 and the density of the solid-residue phase 70. In some embodiments, the first constituent of the lignocellulosic biomass 10 is lignin 12, the second constituent of the lignocellulosic biomass 10 is a water-soluble component of the lingocellulosic biomass 10, such as a hemicellulose or a derivative thereof (e.g., a sugar), and the third constituent of the lignocellulosic biomass 10 is a glucan. In some embodiments, the second constituent of the lignocellulosic biomass 10 may be xylan or a derivative thereof, such as xylose. In some embodiments, the glucan is cellulose. Accordingly, in some embodiments the solid-residue phase 70 may be characterized as a “cellulose-rich phase” or “cellulose-rich material.”

Referring still to FIGS. 1 and 2, the three phases 50, 60, 70 are isolated, as indicated by block 108 in FIG. 2. In this regard, the HDES phase 50, the aqueous phase 60, and the solid-residue phase 70 may be separated from each other and isolated utilizing known phase-separation techniques. In some embodiments, the mixture including the three phases 50, 60, 70, may be filtered to isolate the liquid fraction of the mixture (i.e., the HDES phase 50 and the aqueous phase 60) and the solid fraction (i.e., the solid-residue phase 70). To isolate the HDES phase 50 and the aqueous phase 60 from each other, the liquid fraction containing the HDES phase 50 and the aqueous phase 60 is, in some embodiments, centrifuged and decanted to separate the HDES phase 50 and the aqueous phase 60. Once the HDES phase 50 is isolated from the water phase 60 and the solid-residue phase 70, lignin 12 and HDES 20 within the HDES phase 50 are separated from each other, as indicated by block 110 in FIG. 2. As shown in FIG. 1, in some embodiments, the lignin 12 dissolved in the HDES 20 is recovered. In some embodiments, the lignin 12 is recovered by introducing an anti-solvent 80 into the HDES phase 50 to precipitate the lignin 12 and then isolating the precipitate from the HDES 20 and anti-solvent 80. The empirical rule for selecting an anti-solvent is that it should be miscible with or have a high solubility for a HDES, but exhibit significantly lower solubility for lignin, so that when the anti-solvent is mixed with the HDES, the resulting mixture will have a reduced solubility for lignin, resulting in the precipitation of lignin from the HDES. With this in mind, n-hexane, dimethyl ether, methyl acetate, or ethyl acetate are believed to be suitable anti-solvents for some or all of the HDESs disclosed herein. Accordingly, in some embodiments, the anti-solvent 80 is n-hexane, dimethyl ether, methyl acetate, or ethyl acetate.

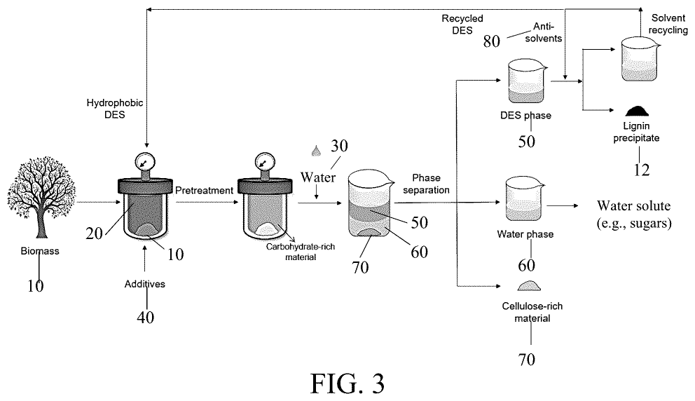

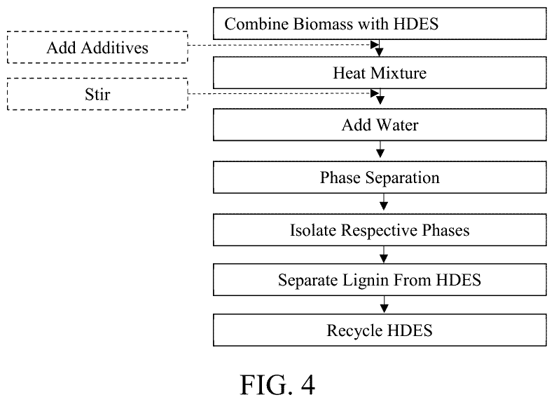

Referring still to FIGS. 1 and 2, in this exemplary embodiment, following recovery of the lignin 12, the HDES 20 is recycled and utilized in the processing of another (or second) lignocellulosic biomass (not shown), as indicated by block 112 in FIG. 2. As shown in FIG. 1, in this exemplary embodiment, the anti-solvent 80 is isolated from the HDES 20 and also recycled so that it can be applied to the HDES phase including dissolved lignin from the second lignocellulosic biomass. In some embodiments, the HDES 20 and the anti-solvent 80 may be separated from each other using known evaporation techniques. Accordingly, the various HDESs 20 and the anti-solvents 80 disclosed herein for use in the exemplary method described above with reference to FIGS. 1 and 2, as well as the exemplary method described below with reference to FIGS. 3 and 4, may be utilized in the processing of multiple lignocellulosic biomasses. In this way, the methods for processing lignocellulosic biomasses disclosed herein can serve to reduce waste generated by, and costs associated with, lignocellulosic biomass processing. In some embodiments, the HDES 20 and the anti-solvent 80 are separated from each other following the recovery of lignin 12 by evaporation and/or distillation.

FIGS. 3 and 4 show certain steps of another exemplary method for processing lignocellulosic biomasses in accordance with the present disclosure. As shown in FIGS. 3 and 4, the steps employed in this exemplary method are the same as the exemplary method described above with reference to FIGS. 1 and 2, except that water 30 is not added to the mixture including the lignocellulosic biomass 10 and HDES 20 until after the mixture including the lignocellulosic biomass 10 and HDES 20, and, in some cases, additive, is heated at the predetermined temperature for the predetermined period of time. Accordingly, the same lignocellulosic biomasses 10, HDESs 20, water 30, additive 40, and anti-solvents 80 utilized within the various embodiments of the exemplary method described above with reference to FIGS. 1 and 2 can be similarly utilized in various embodiments of the exemplary method reflected in FIGS. 3 and 4. Throughout the present disclosure like components are provided with like reference numerals.

The presently-disclosed subject matter is further illustrated by the following specific but non-limiting examples. The following examples may include compilations of data that are representative of data gathered at various times during the course of development and experimentation related to the presently-disclosed subject matter.

### EXAMPLES

The following examples focus on the discovery that certain HDESs, in addition to their aversion to water, are also effective in fractionating a lignocellulosic biomass into a multi-phase system from which constituents of the lignocellulosic biomass, and, in particular, lignin and cellulose-rich material can be easily recovered. The following examples also focus on the discovery that fractionated lignin is dissolved within certain HDESs and can be subsequently recovered therefrom utilizing certain anti-solvents.

### Example 1

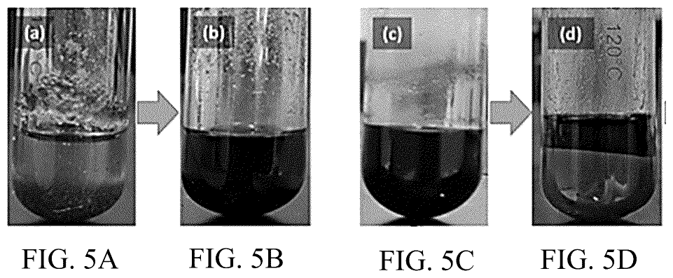

Pinewood was treated with the Thy:Dmp (1:1) HDES for two hours at 140° C. in 1:10 w/w ratio of pinewood to HDES. Following heating, ethyl acetate was added to the mixture as an anti-solvent to precipitate lignin dissolved in the HDES (FIGS. 5A and 5B). As shown by viewing FIGS. 5A and 5B in sequence, the change in color of the HDES following heating suggested that at least some lignin was extracted from the pinewood sample and that an HDES can be employed in the fractionation of a lignocellulosic biomass. When ethyl acetate was added to the sample, the precipitation of lignin was slight and thus not readily discernable in the image corresponding to FIG. 5B. As such, further a further test was conducted to further examine the efficacy of an anti-solvent to recover lignin from HDES.

Kraft lignin was treated with the Thy:Dmp (1:1) HDES for one-half hour at 80° C. in 1:10 w/w ratio of lignin to HDES. The resultant homogenous liquid suggested that lignin can be easily dissolved in HDES (FIG. 5C). Following heating, ethyl acetate was added to the mixture as an anti-solvent to precipitate lignin dissolved in the HDES (FIG. 5D). As reflected by the two distinct phases in the image corresponding to FIG. 5D, following heating and the application of ethyl acetate as an anti-solvent, lignin was readily precipitated from the HDES, thus validating the concept that a suitable anti-solvent can be employed to recover lignin from an HDES phase.

### Example 2

### Materials and Methods

Materials. Raw samples of wheat straw and hybrid poplar wood were collected as reference materials from the National Renewable Energy Laboratory (NREL). Prior to use, these samples were ground into 1 mm using a knife mill. The compositional analysis showed that the wheat straw comprised 34.21±0.20% glucan, 19.38±0.08% xylan, 18.98±0.08% lignin, and 6.43±1.99% ash, while poplar wood contained 47.34±1.47% glucan, 17.49±0.59% xylan, 22.55±0.17% lignin, and 0.36±0.19% ash. Acetone (≥99.5%), ethyl acetate (≥98.0%), and aluminum chloride hexahydrate (AlCl₃·6H₂O, 99%) were purchased from VWR International, TCI American, and Thermo Scientific Chemicals, respectively. All other chemicals were supplied by Sigma-Aldrich with high purity. Commercial enzymes, including cellulase (Cellic® CTec2) and hemicellulase (Cellic® HTec2), were generously provided by Novozymes, North America (Franklinton, NC, USA). The lignin-based HDESs used in this work were prepared based on the previous work.⁹

HDES-mediated fractionation process. For the pretreatment of biomass using lignin-based HDESs, 1.5 g of either wheat straw or poplar wood was combined with a 15 g mixture of HDESs and water (or an acidic aqueous solution) in a 1:1 weight ratio within an ACE glass pressure vessel reactor. The resulting mixture was left to stand overnight to ensure thorough penetration of the pretreatment solution into the biomass. Subsequently, the reactor was heated to 140° C. in an oil bath and maintained at this temperature for one hour while being stirred continuously at 500 RPM. Upon completion of the pretreatment, the reactor was air-cooled to room temperature. The solid residues and liquid fractions were then separated via suction filtration. After the filtration, the solid residues were rinsed with acetone and water to remove any residual pretreatment agents. Meanwhile, the liquid fractions were collected and centrifuged at 2000 RPM for 5 minutes, facilitating the clear separation of the HDES and aqueous phases for subsequent processing and analysis.

Compositional Analysis. The chemical compositions of the biomass, both pre- and post-pretreatment, were analyzed following the NREL laboratory analytical procedure NREL/TP-510-42618.^{6, 36} Briefly, the sample tested was subject to a two-stage acid hydrolysis where monomeric sugars and lignin were released from the biomass matrix. These released sugars were then quantified using a High Performance Liquid Chromatography (HPLC) system equipped with a refractive index detector. As the contents of galactose, mannose, and arabinose were negligible (<2%) in the samples, a Biorad Aminex HPX-87P column was used for the HPLC measurement of glucose and xylose with sulfuric acid (5 mM) as the mobile phase at a flow rate of 0.6 mL/min and a column temperature of 65° C. The acid-soluble lignin in the hydrolysate was determined by a UV-vis spectrometer, whereas the acid-insoluble lignin content was obtained by weighing the post-hydrolysis solid residues and subtracting the ash content. Additionally, the sugars and degradation products in the liquid phase from the pretreatment process were characterized based on the NREL/TP-510-42623 method.³⁵ The solid recovery, glucan retention, lignin removal, and xylan removal after pretreatment were calculated using the following equations:

$$\begin{matrix}Solid recovery rate ( \% ) = \frac{{m}_{s}}{{m}_{0}} \times 100 \\ Glucan retention rate ( \% ) = \frac{{m}_{s , gluan}}{{m}_{0 , glucan}} \times 100 \\ Lignin removal rate ( \% ) = ( 1 - \frac{{m}_{s , lignin}}{{m}_{0 , lignin}} ) \times 100 \\ Xylan removal rate ( \% ) = ( 1 - \frac{{m}_{s , xylan}}{{m}_{0 , xylan}} ) \times 100\end{matrix} ,$$

where mₛ, m_{s,glucan}, m_{s,lignin}, and m_{s,xylan} represents the mass of the solid residues and the mass of glucan, lignin, and xylan in the solid residues, respectively. Similarly, m₀, m_{0,glucan}, m_{0,lignin}, and m_{0,xylan} represents the mass of the raw biomass and the mass of glucan, lignin, and xylan in the raw biomass, respectively.

Characterization of untreated and pretreated biomass. The morphology of the biomass structure before and after pretreatment was observed using scanning electron microscopy (SEM). The SEM images were captured using an SEM instrument (Quanta FEG 250, FEI company, USA) operating at an accelerating voltage of 10 kV. Prior to imaging, the samples were sputter-coated with a thin layer of gold to enhance their conductivity.

The chemical structure change of the biomass after the fractionation process was analyzed using Fourier transform infrared spectroscopy (FTIR). FTIR spectra were acquired using a FTIR spectrometer (Nicolet iS50, Thermo Fisher Scientific, USA) in attenuated total reflectance mode. The spectral data were collected at a resolution of 4 cm-1 over a wavenumber range of 4000-400 cm-1.

Additionally, X-ray Powder Diffraction (XRD) was employed to investigate the crystallinity of the untreated and pretreated biomass samples. Measurements were conducted over a 2θ range of 5-40°, with a step size of 0.02° and a scan rate of 2°/minute. The crystallinity index (CrI) was calculated based on the following formula:

$$CrI = \frac{{I}_{002} - {I}_{am}}{{I}_{002}} \times 100 ,$$

where the I₀₀₂ is the intensity of 002 lattice diffraction (cellulose crystallinity portion) at around 2θ=22.6° and the Iₐₘ is the intensity of amorphous section at around 2θ=15.6°.³¹

Enzymatic saccharification. The efficiency of the biomass fractionation process was assessed through enzymatic saccharification, following the NREL/TP-510-42629 method.³¹ The solid substrates were enzymatically hydrolyzed in a 50 mM sodium citrate buffer at pH 4.8 with a solid loading of 2% (w/v), maintained at 50° C. for 72 hours with constant agitation at 200 RPM. Cellulase (CTec2), exhibiting an activity of 132 Filter Paper Units per milliliter (FPU/mL) as determined by the NREL/TP-510-42628 method¹¹, was added at an enzyme loading of 60 FPU/g glucan. The concentration of glucose produced during this hydrolysis was quantified using HPLC, and the yield of glucose was calculated based on the following formula:

$$Glucose yield ( \% ) = \frac{0.9 \times mass of the glucose produced}{mass of the glucan in the substrate} \times 100.$$

Lignin recovery and characterization. The lignin isolated in the HDESs was precipitated by adding ethyl acetate as an anti-solvent at twice the volume of the HDESs. The resultant lignin precipitate was collected by centrifugation at 4000 RPM for 10 minutes, washed with ethanol several times, and subsequently freeze-dried for further analysis. The wheat straw and poplar wood lignin precipitates from HDESs pretreatment were labeled as WS-HDES-L and PW-HDES-L, respectively.

For comparison, enzymatic mild acidolysis lignin (EMAL) was obtained to represent the native lignin within the biomass, using a procedure modified from previous reports. 20, 41 Initially, the biomass sample was thoroughly extracted with a toluene-ethanol solution (2/1, v/v) in a Soxhlet extractor for 24 h. The extractive-free biomass was then subjected to ball milling at 600 RPM for 2 h, with intermittent pauses every five minutes to mitigate thermal buildup. The finely milled biomass was treated with an excess of CTec2 and HTec2 enzymes in a 50 mM sodium citrate buffer (pH 4.8 at 50° C.) for 48 hours, a process which was repeated twice to ensure thorough hydrolysis. The hydrolysis residue was separated via centrifugation, thoroughly washed with a dilute hydrochloric acid (HCl) solution (pH 2), and then lyophilized to obtain crude lignin. The dried lignin was further purified through extraction in an acidic dioxane-water solution (85:15 v/v, containing 0.01 mol/L HCl) at 86° C. for 2 h. The mixture obtained was then filtered, and the filtrate was neutralized using sodium bicarbonate. The neutralized solution was subsequently added dropwise to 1 L HCL solution (pH 2) to induce lignin precipitation, which was eventually freeze-dried to yield EMAL. The EMAL from wheat straw and poplar wood were labeled as WS-EMAL and PW-EMAL, respectively.

The molecular weight distributions of the lignin samples were analyzed using gel permeation chromatography (GPC), while their chemical structures were investigated by two-dimension heteronuclear single quantum coherence nuclear magnetic resonance (2D HSQC NMR) spectroscopy.

HDES recovery. The recovery of the HDES and anti-solvent was carried out using a rotary evaporator at 30° C. under vacuum. During the recovery procedure, the anti-solvent was collected in the flask attached to the evaporator, while the HDES was retained in the rotary flask. The purity and composition of the recovered anti-solvent and HDES were analyzed using a gas chromatography-mass spectrometry (GC/MS) system (7890B/5977A, Agilent Technologies, USA).

### Results and Discussion

In the study underlying this Example, lignin-based HDESs, specifically thymol-2,6-dimethoxyphenol (Thy:Dmp) in molar ratios of 1:1, 1:2, and 2:1, were utilized. These HDESs were selected based on the inventors' prior research, where their synthesis and characterization were detailed.^{2,9} Briefly, these HDESs are highly stable and show clear phase separation with water, thereby facilitating the formation of the biphasic solvent system. Moreover, they exhibit significantly lower viscosity compared to conventional DESs, a property that greatly enhances their suitability for practical applications.

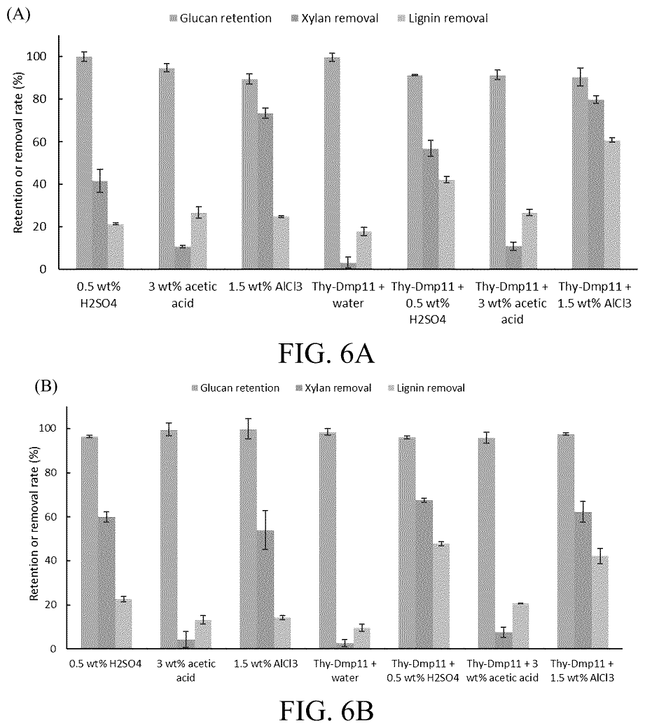

Solid compositional analysis and pretreatment efficiency. Wheat straw and poplar wood were subjected to pretreatment using the HDES (Thy:Dmp (1:1))-water systems at 140° C. for 1 h. The compositional changes in the solid residues post-pretreatment are summarized in TABLE 3. Additionally, the retention rates of glucan and the removal rates of xylan and lignin were calculated accordingly and are presented in FIGS. 6A-6B. It can be observed that the HDES-water pretreatment results in a significant increase in the glucan and xylan contents in the residues of both wheat straw and poplar wood, which is likely due to the removal of other biomass extractives with minimal loss of glucan and xylan. Interestingly, the lignin content remains relatively unchanged, as lignin is also extracted into the HDES-water system during pretreatment, although to a small extent (9.65-17.79%). The poor removal rate of xylan (2.56-3.14%) and lignin may be attributed to the neutral nature of the HDES applied, which lacks the capacity to effectively break down the glycosidic bonds in xylan and the ether/ester linkages in lignin-carbohydrate complexes (LCC).

TABLE 3
Composition of raw biomass and solid residues after pretreatment.

| | | Solid composition | | | Solid |
|---|---|---|---|---|---|
| Biomass | | Glucan | Xylan | Lignin | recovery |
| feedstock | Pretreatment | (%) | (%) | (%) | (%) |
| Wheat | Raw | 34.21 ± 0.20 | 19.38 ± 0.08 | 18.98 ± 0.08 | |
| straw | 0.5 wt % H₂SO₄ | 55.14 ± 1.50 | 17.44 ± 1.38 | 22.95 ± 0.35 | 65.13 ± 0.96 |
| | 3 wt % acetic acid | 45.52 ± 1.57 | 24.35 ± 0.48 | 19.56 ± 0.46 | 71.19 ± 0.95 |
| | 1.5 wt % AlCl₃ | 51.55 ± 2.69 | 8.68 ± 0.59 | 24.10 ± 0.54 | 59.35 ± 1.62 |
| | Thy:Dmp1:1 + water | 42.41 ± 1.08 | 24.86 ± 0.87 | 19.40 ± 0.56 | 80.45 ± 1.91 |
| | Thy:Dmp1:1 + 0.5 | 60.03 ± 1.88 | 16.01 ± 0.96 | 21.15 ± 0.83 | 52.05 ± 1.57 |
| | wt % H₂SO₄ | | | | |
| | Thy:Dmp1:1 + 3 wt % | 43.45 ± 0.66 | 24.02 ± 0.20 | 19.37 ± 0.14 | 71.94 ± 1.78 |
| | acetic acid | | | | |
| | Thy:Dmp1:1 + 1.5 | 66.27 ± 2.22 | 8.38 ± 0.70 | 15.90 ± 0.23 | 46.44 ± 0.30 |
| | wt % AlCl₃ | | | | |
| Poplar | Raw | 47.34 ± 1.47 | 17.49 ± 0.59 | 22.55 ± 0.17 | |
| wood | 0.5 wt % H₂SO₄ | 65.64 ± 0.67 | 10.07 ± 0.57 | 25.10 ± 0.40 | 69.54 ± 0.38 |
| | 3 wt % acetic acid | 55.18 ± 0.92 | 19.06 ± 0.33 | 22.29 ± 0.61 | 87.91 ± 1.95 |
| | 1.5 wt % AlCl₃ | 60.11 ± 2.99 | 10.18 ± 1.59 | 24.62 ± 0.71 | 78.67 ± 3.08 |
| | Thy:Dmp1:1 + water | 53.40 ± 0.97 | 19.54 ± 0.36 | 23.36 ± 0.50 | 87.21 ± 0.22 |
| | Thy:Dmp1:1 + 0.5 | 75.27 ± 2.90 | 9.42 ± 0.62 | 19.55 ± 0.68 | 60.45 ± 2.79 |
| | wt % H₂SO₄ | | | | |
| | Thy:Dmp1:1 + 3 wt % | 53.07 ± 1.24 | 18.93 ± 0.41 | 20.94 ± 0.11 | 85.46 ± 0.42 |
| | acetic acid | | | | |
| | Thy:Dmp1:1 + 1.5 | 69.84 ± 2.17 | 9.95 ± 0.99 | 19.73 ± 0.70 | 66.13 ± 1.70 |
| | wt % AlCl₃ | | | | |

To enhance the effectiveness of the pretreatment, various acids or salts were incorporated into the aqueous phase to catalyze the cleavage of covalent bonds interlinking biomass components as well as the depolymerization of hemicellulose and lignin, thereby facilitating the fractionation of these components. It is found that introducing acids or salts into the HDES-water system profoundly improves the removal of xylan and lignin, leading to an increase in cellulose proportion and a decrease in lignin and xylan contents within the pretreated biomass residues. For instance, incorporating sulfuric acid (H₂SO₄) into the HDES-water system boosts xylan removal from 3.14% to 56.96% and lignin removal from 17.79% to 42.06% in wheat straw. This enhancement is more pronounced with the use of stronger acids like H₂SO₄ (a strong Brønsted acid) and aluminum chloride (AlCl₃) (a strong Lewis acid) compared to weaker acids like acetic acid, indicating the significant role of acid strength in fractionation efficiency. To elucidate the effects of HDESs, control experiments using only acid solutions were conducted. Results indicate that the combined use of HDES and acid solutions is more effective in removing xylan and lignin than acids alone, suggesting a synergistic effect between HDESs and acids in the fractionation process. Acids are efficient in breaking down glycosidic bonds, ether bonds and LCC linkage, thereby facilitating the detachment and release of xylan and lignin from the biomass matrix. However, a portion of this detached lignin often re-deposits onto the biomass surface as spheres, which consequently diminishes the lignin removal rate. Given that DESs usually exhibit high lignin solubility, it is plausible that in the HDES-acidic aqueous system, the released lignin dissolves into the HDES phase, preventing its re-deposition on the surface and thus enhancing both hemicellulose and lignin removal. Interestingly, the use of AlCl₃ resulted in greater removal efficiencies compared to H₂SO₄ for wheat straw, an effect not observed in poplar wood. This discrepancy might be attributed to the interaction of H⁺ with the ash content, which is higher in wheat straw than in poplar wood, potentially consuming H₂SO₄ and yielding fewer catalytic sites for biomass deconstruction. Additionally, the pretreatment process proved less effective for poplar wood compared to wheat straw under identical conditions, which is possibly due to the inherently higher resistance of woody biomass to chemical degradation as compared to herbaceous biomass, mainly resulting from the elevated lignin content in woods.

Molar ratios of DESs are known to influence the effectiveness of DES-based biomass pretreatment methods. The impact of HDESs at different molar ratios on the efficiency of biomass fractionation was explored. A 1.5 wt % AlCl₃ solution was used in conjunction with the HDES due to its excellent performance in pretreating both wheat straw and poplar wood, as mentioned before. The results are detailed in TABLE 4, which indicates that the effectiveness of HDESs at different molar ratios follows the order: Thy:Dmp 1:2≈Thy:Dmp 1:1>Thy:Dmp 2:1. Considering that Dmp structurally resembles lignin units (S type), a reduced molar ratio of Dmp in the HDESs likely diminishes the solvent's capacity to dissolve lignin according to the “like dissolve like” principle, resulting in lower lignin removal efficiency.

TABLE 4
Effects of HDES molar ratios on the chemical composition of the treated solids and the removal of xylan and lignin.

| | | Solid composition | | | Solid | Glucan | | |
|---|---|---|---|---|---|---|---|---|
| | | Glucan | | | recovery | Retention | Removal (%) | |
| Sample | HDES | (%) | Xylan (%) | Lignin (%) | (%) | (%) | Xylan | Lignin |
| Wheat | Thy:Dmp1:1 | 66.27 ± 2.22 | 8.38 ± 0.70 | 15.90 ± 0.23 | 46.44 ± 0.30 | 90.46 ± 4.21 | 79.82 ± 1.76 | 60.89 ± 1.00 |
| straw | Thy:Dmp1:2 | 66.39 ± 1.46 | 9.14 ± 0.42 | 14.83 ± 0.89 | 47.32 ± 1.37 | 91.78 ± 1.31 | 77.67 ± 1.52 | 62.96 ± 3.28 |
| | Thy:Dmp2:1 | 61.36 ± 1.11 | 8.44 ± 0.45 | 17.50 ± 0.55 | 49.18 ± 0.90 | 88.19 ± 2.19 | 78.57 ± 1.36 | 54.67 ± 1.14 |
| Poplar | Thy:Dmp1:1 | 69.84 ± 2.17 | 9.95 ± 0.99 | 19.73 ± 0.70 | 66.13 ± 1.70 | 97.49 ± 0.55 | 62.29 ± 4.73 | 42.07 ± 3.48 |
| wood | Thy:Dmp1:2 | 70.95 ± 2.84 | 10.22 ± 1.30 | 19.19 ± 1.06 | 67.58 ± 1.10 | 98.24 ± 2.96 | 60.47 ± 5.50 | 42.45 ± 3.78 |
| | Thy:Dmp2:1 | 68.74 ± 2.68 | 10.09 ± 1.05 | 20.49 ± 0.66 | 67.80 ± 1.14 | 98.47 ± 4.63 | 60.85 ± 4.32 | 38.39 ± 2.34 |

In conclusion, the integration of HDESs with acidic solutions markedly improved the efficiency of removing lignin and xylan from biomass. Among the various combinations evaluated, the HDES mixed with a 1.5 wt % AlCl₃ solution emerged as the most effective, as evidenced by its superior delignification (42.07-60.89%) and xylan removal (62.29-79.82%), while still maintaining high glucan retention rates (90.46-97.49%) for both wheat straw and poplar wood. Furthermore, AlCl₃ solution is less corrosive than that of H₂SO₄. Thus, this combination was selected in subsequent investigations.

The integration of Thy:Dmp (1:1) with a basic additive (1 wt % sodium hydroxide (NaOH)) was also tested. After subjecting a sample of wheat straw to the pretreatment of Thy:Dmp (1:1)-NaOH at 140° C. for three hours, solid recovery from the sample was 61% and lignin removal rate was 45.5%. Unfortunately, due to instrumentation malfunctions, no data was able to be gathered for cellulose retention and hemicellulose removal.

### Structural Characteristics of Untreated Biomass and Treated Biomass Residues.

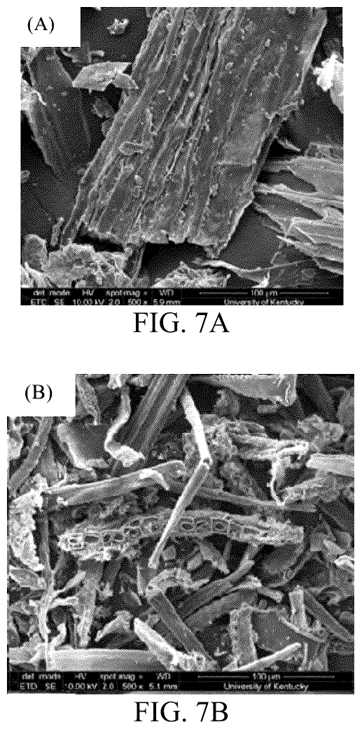

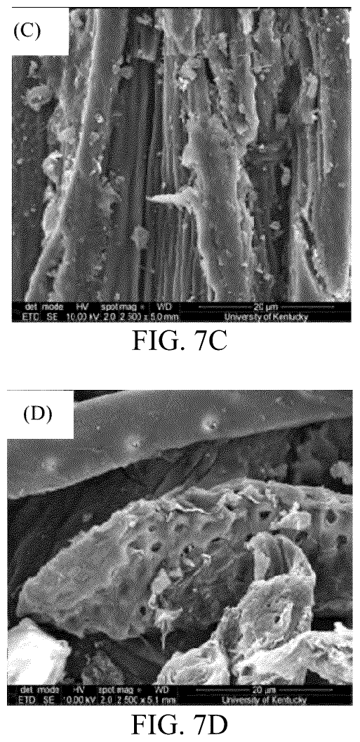

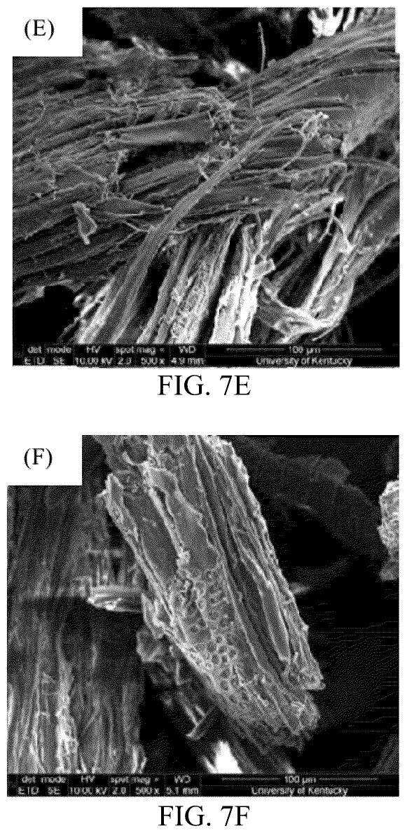

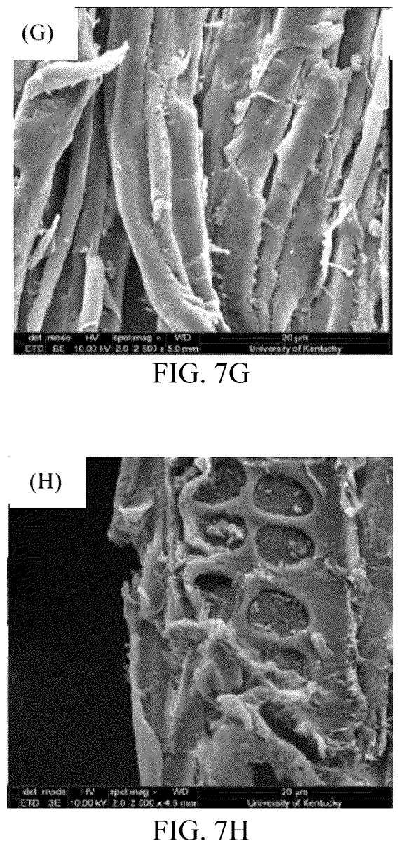

To gain a deeper insight into the structural changes experienced by wheat straw and poplar wood due to the Thy:Dmp (1:1)-AlCl₃ pretreatment, the surface morphologies of the raw biomass and the cellulose-rich residues post-pretreatment were examined using SEM. As depicted in FIGS. 7A-7H, the untreated wheat straw presents a dense and intact structure with fibers neatly arranged in bundles and noticeable flakes on the surface. In contrast, the wheat straw subjected to HDES-AlCl₃ pretreatment exhibits a visibly disrupted fiber structure with apparent cracks and erosions on the surface. A similar trend is observed in poplar wood. The surface morphology of untreated wood, initially fibrous and smooth, becomes rough and porous following the HDES-AlCl₃ pretreatment. These changes suggest that the HDES-AlCl₃ pretreatment induces considerable structural modifications in the biomass, likely facilitating the exposure of the internal structure, a consequence primarily attributed to the removal of lignin and hemicellulose.

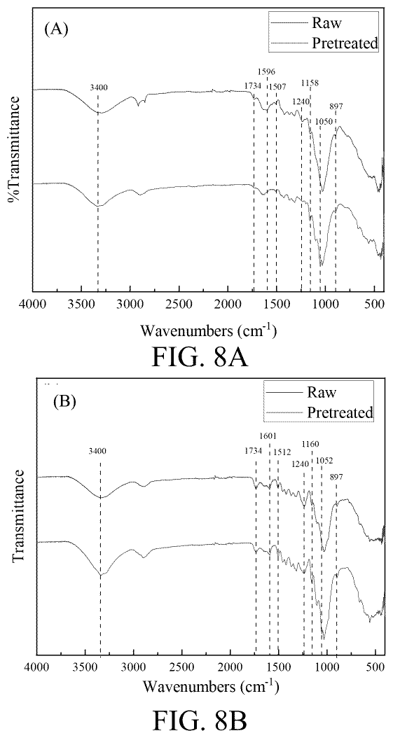

FTIR analysis of the raw materials and Thy:Dmp (1:1)-AlCl₃ treated materials was conducted to elucidate the changes in functional groups during the pretreatment process. As shown in FIGS. 8A-8B, the FTIR spectra of both raw wheat straw and poplar wood show characteristic peaks associated with cellulose, hemicellulose, and lignin. The peaks at 3400 cm-1 can be assigned to the O—H stretching vibrations, predominantly arising from the hydrogen bond and hydroxyl group in cellulose. Cellulose also presents characteristic peaks at around 897 cm-1,1160 cm-1, and 1050 cm-1, corresponding to the β-(1→4) glycosidic linkage vibrations, C—O—C stretching vibration, and C—O stretching vibration, respectively. The spectral peaks at around 1512 cm-1 and 1601 cm-1 are attributed to the aromatic skeletal vibrations of lignin. Additionally, the peaks at 1734 cm-1 and 1240 cm-1 are associated with the stretching vibrations of C═O and C—O in hemicellulose, respectively. After the HDES-AlCl₃ pretreatment, the FTIR spectra of both wheat straw and poplar wood do not exhibit significant shifts in peak positions. However, there is a reduction in the intensity of peaks associated with lignin and hemicellulose, coupled with an increase in the intensity of peaks related to cellulose, indicating the removal of lignin and hemicellulose during the pretreatment process, while the cellulose structure remained relatively unchanged.

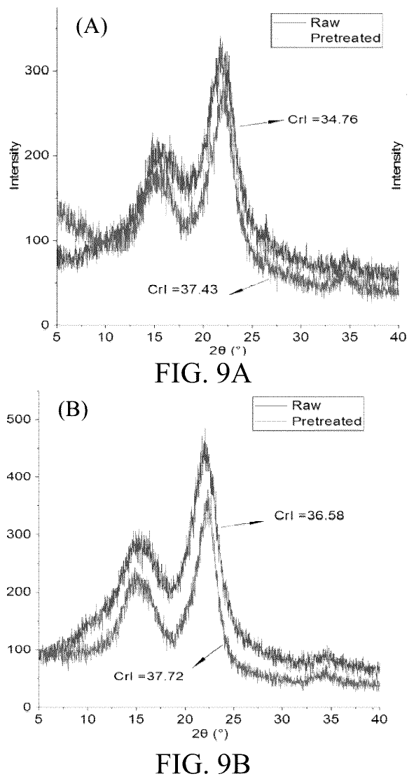

FIGS. 9A-9B show the XRD patterns and corresponding CrI values of the biomass samples before and after Thy:Dmp (1:1)-AlCl₃ pretreatment. The XRD patterns reveal a slight increase in the crystallinity of the biomass samples after pretreatment, with CrI rising from approximately 34.76% to 37.43% for wheat straw, and from 36.58% to 37.72% for poplar wood. The increase in the CrI values can be attributed to the removal of amorphous components such as hemicellulose and lignin, which leaves behind a higher proportion of crystalline cellulose in the pretreated biomass. Such findings are consistent with the results obtained from compositional analysis and FTIR analysis.

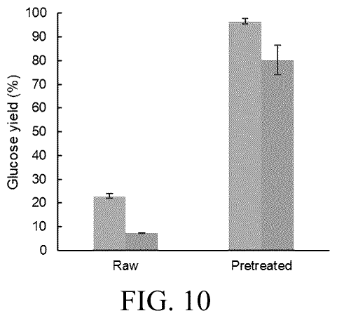

Ezymatic saccharification. Enzymatic saccharification, a process where cellulose is enzymatically hydrolyzed into glucose, is a crucial criterion for assessing the effectiveness of a pretreatment method. FIG. 10 shows the enzymatic saccharification results of the cellulose-rich solids obtained from Thy:Dmp (1:1)-AlCl₃ pretreatment, with their corresponding untreated materials as controls. The results clearly demonstrate that, after a 72-hour incubation under identical conditions, the pretreated biomass exhibits remarkable glucose yields: 96.48% from wheat straw and 80.22% from poplar wood, which are approximately 4.2 times greater than those from untreated wheat straw and about 11.0 times higher than from untreated poplar wood, respectively. These results suggest that the HDES-AlCl₃ pretreatment significantly enhances the enzymatic digestibility of cellulose in both wheat straw and poplar wood. This enhancement can be ascribed to the disruption of biomass structure and the removal of lignin and hemicellulose. Lignin typically acts as a physical barrier and, along with hemicellulose, forms LCC, which restricts the accessibility of cellulose to enzymes. Lignin is also known to inhibit cellulase activity through non-productive binding. Thus, the elimination of lignin and hemicellulose during the HDES-AlCl₃ pretreatment results in increased enzyme efficiency for cellulose hydrolysis. Moreover, the breakdown of the biomass's ordered structure further enhances the exposure of cellulose to enzymatic action. As a result, the saccharification efficiency of cellulose is significantly improved after the pretreatment.

### Composition Analysis of the Aqueous Phase.

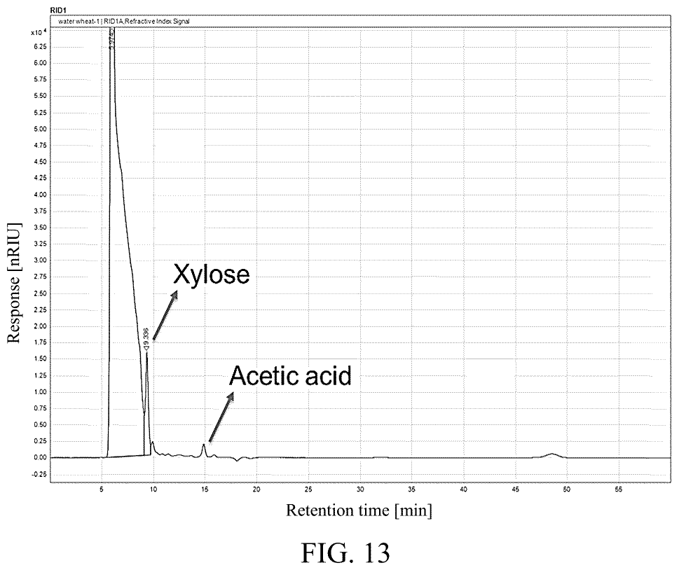

The products dissolved in the aqueous phase were analyzed by HPLC (FIG. 13) The HPLC analysis reveals that the aqueous phase primarily contained high concentrations of xylose, which accounts for 36.06% of the xylan removed from wheat straw and 46.16% from poplar wood. The discrepancy between the xylan removed and the xylose detected suggests that a portion of the xylan likely transformed into other derivatives, such as furfural, which predominantly partition into the HDES phase. Additionally, acetic acid was detected in the aqueous solution at a relatively low concentration (0.11-0.15 mg/mL), originating from the dissociation of acetyl groups in the hemicellulose fraction. In the HPLC chromatogram, there are also peaks that could potentially correspond to other biomass degradation products, such as furfural and 5-hydroxymethylfurfural. However, standards are needed for the identification and confirmation of these compounds.

Recovery and characterization of lignin in HDES phase. The lignin dissolved in the Thy:Dmp (1:1) HDES phase was isolated by introducing ethyl acetate as an anti-solvent, which prompted the lignin to precipitate out of the solution. Following precipitation, the lignin was washed, dried, and its dry mass was measured. It was observed that the lignin yield obtained through this method constituted only about 31-42% of the total lignin removed, suggesting that ethyl acetate is relatively inefficient in precipitating the majority of the lignin content from the solution. This limited efficiency was further evidenced by the retained dark color of the HDES-ethyl acetate mixture after lignin precipitation. The limited efficiency of ethyl acetate prompted the subsequent testing of another anti-solvent, namely, n-hexane. Under similar testing conditions, n-hexane was found to precipitate lignin in the Thy:Dmp (1:1) HDES phase at a rate of 58-65%, a significant increase as compared to ethyl acetate.

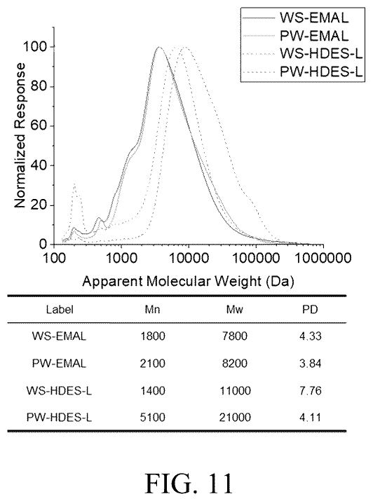

To gain deeper insights into the process and guide future optimization, the molecular weight distribution and chemical composition of the precipitated lignin (HDES-L) were examined using GPC and 2D HSQC NMR spectroscopy, respectively. As reflected in FIG. 11, the HDES-L from both wheat straw and poplar wood show significantly higher weight average molecular weight (Mw) and number average molecular weight (Mn) than compared to EMAL lignin, which appears to contrast with previous studies that suggest DES can stabilize the depolymerized lignin, yielding lower molecular weight products. This may be due to the anti-solvent selectively precipitate lignin with higher molecular weight.

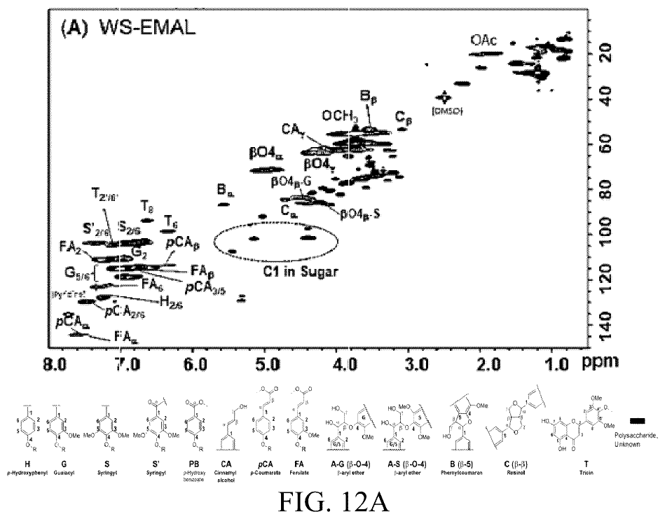

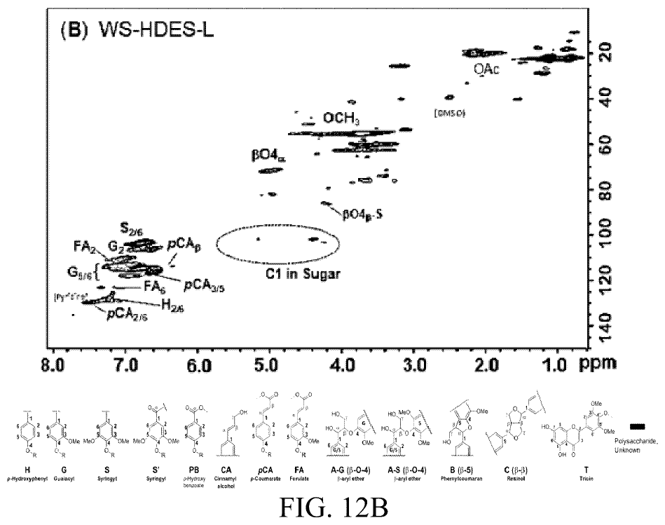

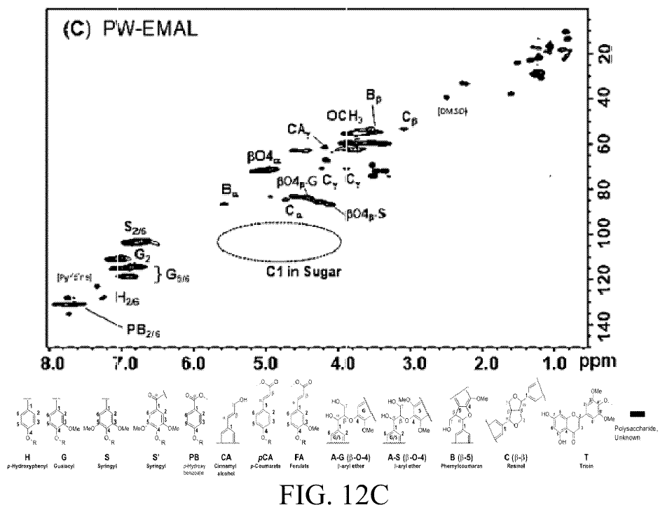

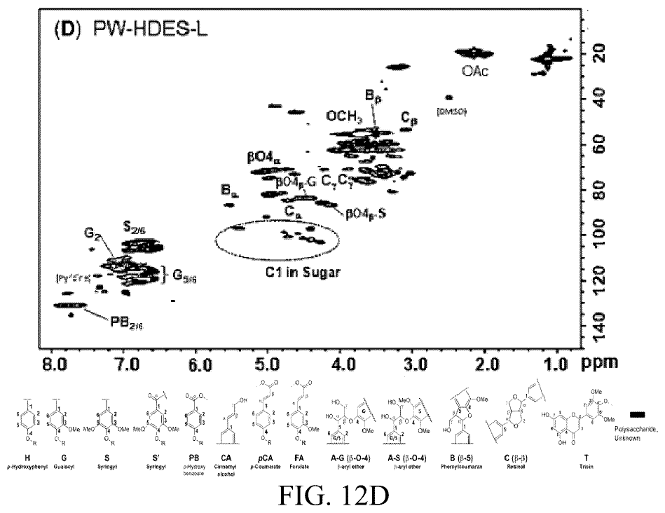

FIGS. 12A-12D show the 2D HSQC NMR spectra, alongside the relevant structural units of lignin samples. In the aliphatic side chain region of lignin (δ_{c}/δ_{H} 50-90/3-5.5 ppm), the most pronounced signal is attributable to the methoxy group, followed by the aromatic ether bond β-O-4 (labeled as A). Other significant signals include the phenylcoumaran linkage β-5 (B) and the resinol linkage β-β (C). After pretreatment, a comparison with EMAL revealed that in HDES-L samples, the signals for Aα (δ_{c}/δ_{H} 71.5/4.86 ppm) and Aβ(S) (δ_{c}/δ_{H} 86.6/4.07) diminished substantially. Meanwhile, the signals for Aβ(G) (δ_{c}/δ_{H} 83.4/4.32 ppm), Bα (δ_{c}/δ_{H} 87.3/5.45 ppm), Bβ (δ_{c}/δ_{H} 53.2/3.61 ppm), Cα (δ_{c}/δ_{H} 84.8/4.65 ppm), and Cβ (δ_{c}/δ_{H} 54.2/3.10 ppm) were no longer detectable. These changes suggest that the pretreatment process effectively facilitated the cleavage of β-O-4 bonds and the more robust C—C linkages within lignin, resulting in its fragmentation, which is beneficial for further value-added utilization.

In the aromatic ring region of lignin (δ_{c}/δ_{H} 90-160/5.5-8 ppm), the predominant aromatic units include syringyl (S), guaiacyl (G), and p-hydroxyphenyl (H) units. In the WS-EMAL, these units are accompanied by the distinct signals of tricin (T), p-coumaric acid (PCA), and ferulic acid (FA), which are characteristic of herbaceous lignin. Conversely, PW-EMAL predominantly features p-hydroxybenzoate units, a common structural component in poplar wood lignin. Following the HDES-AlCl₃ pretreatment, the signals corresponding to S and H units in the WS-HDES-L are either significantly reduced or disappeared, predominantly leaving behind G units. This observation suggests that S units in lignin are highly reactive and susceptible to alterations during the pretreatment process. Typically, S units undergo demethoxylation and demonstrate higher reactivity, making them more prone to removal or depolymerization. Furthermore, signals indicating the presence of PCA and FA in the WS-HDES-L are notably diminished, with the specific signal for FA/pCAα (δ_{c}/δ_{H} 145.2/7.53 ppm) disappearing entirely. These changes are indicative of the cleavage of covalent bonds between lignin and carbohydrates, contributing to the partial disassembly of LCCs and the subsequent dissociation of lignin from carbohydrates. In the PW-HDES-L, however, the extent of bond and linkage disruption was less pronounced compared to WS-HDES-L. This outcome suggests a lower degree of lignin depolymerization and dissociation in PW-HDES-L, a finding that aligns with the results of the chemical analysis.

### Recovery of HDES and Anti-Solvent.

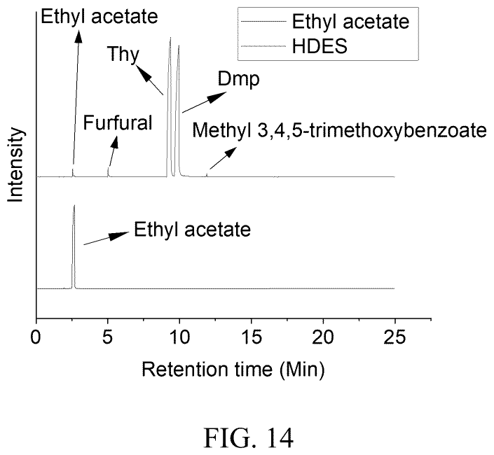

The mixture of Thy:Dmp (1:1) and ethyl acetate mixture after lignin precipitation was treated by a rotary evaporator for their separation and recovery. It was found that ethyl acetate could be readily evaporated from the mixture at 30° C. under reduced pressure, leaving the HDES component behind. The recovery rate of ethyl acetate reached approximately 90%, with its purity exceeding 98% as indicated by GC-MS (FIG. 14). These results indicate the feasibility of efficiently separating and recovering ethyl acetate from the HDES-ethyl acetate mixture, facilitating its potential reuse. The GC-MS chromatogram of the remaining liquid in the rotary flask shows two primary peaks corresponding to the components of HDES (FIG. 14), suggesting that the remaining liquid predominantly comprised HDES. A small proportion of ethyl acetate (<2%) was also detected. Notably, a significant peak attributed to furfural was identified, implying its formation during the separation process. Given that furfural is a valuable platform chemical, additional procedures may be required for its extraction from the HDES phase. While minimal, several peaks related to lignin derivatives are also present in the GC-MS analysis, suggesting the residual lignin within the HDES. This finding aligns with the discussion above regarding the incomplete precipitation of lignin from HDES when ethyl acetate was utilized.

Conclusion. In the study underlying this example, the fractionation of biomass using a biphasic system composed of HDESs and an acidic aqueous solution was investigated. The results indicate that the biphasic system shows synergistic effects in the removal of lignin and hemicellulose, contributing to a significant increase in cellulose accessibility and digestibility. This is accomplished through the acid-induced degradation and detachment of hemicellulose and lignin, followed by the selective dissolution of lignin into the HDES phase. Additionally, this process enables the separation of the removed lignin and hemicellulose into distinct phases, realizing a simultaneous fractionation of the biomass components.

During the study underlying this example, wheat straw and poplar wood samples were also tested under alternative treatment conditions relative to those specifically described. Each treatment condition examined during the study underlying this example, including those described above, are reflected in TABLE 5 below.

TABLE 5
Recovery rate and lignin content of solid residues after pretreatment with binary
HDES or control and subsequent lignin removal from wheat straw and poplar wood.

| | | | | Solid residue | | | | | | |
|---|---|---|---|---|---|---|---|---|---|---|
| | | | | (Cellulose-rich | | | | | | |
| | | | | material) | | | Solid | | | |
| | | | Pretreatment | Cellulose | Hemicellulose | Lignin | recovery | Cellulose | Removal (%) | |
| Sample | Solvent | Additive | condition | (%) | (%) | (%) | (%) | retention(%) | Hemicellulose | Lignin |
| Wheat | DES-1 + | 0.5 | 140° C., 3 h | 65.24 | 10.53 | 14.02 | 44.72 | 85.28 | 75.71 | 64.58 |
| Straw | water | wt % | | | | | | | | |
| | | H₂SO₄ | | | | | | | | |
| | DES-1 + | 0.5 | 120° C., 1 h | 54.47 | 19.95 | 15.03 | 59.86 | 95.31 | 38.39 | 49.17 |
| | water | wt % | | | | | | | | |
| | | H₂SO₄ | | | | | | | | |
| | DES-1 + | 0.5 | 120° C., 2 h | 56.10 | 18.54 | 16.21 | 56.43 | 92.54 | 46.03 | 48.32 |
| | water | wt % | | | | | | | | |
| | | H₂SO₄ | | | | | | | | |
| | DES-1 + | 0.5 | 120° C., 3 h | 60.87 | 16.87 | 15.85 | 54.83 | 97.56 | 52.29 | 50.9 |
| | water | wt % | | | | | | | | |
| | | H₂SO₄ | | | | | | | | |
| | DES-1 + | 0.5 | 120° C., 1 h | 44.25 | 24.32 | 16.17 | 71.97 | 93.09 | 9.70 | 34.25 |
| | water | wt % | | | | | | | | |
| | | Malic | | | | | | | | |
| | | acid | | | | | | | | |
| | DES-1 + | 0.5 | 120° C., 2 h | 43.81 | 23.82 | 16.63 | 69.88 | 89.48 | 14.14 | 34.34 |
| | water | wt % | | | | | | | | |
| | | Malic | | | | | | | | |
| | | acid | | | | | | | | |
| | DES-1 + | 0.5 | 120° C., 3 h | 45.88 | 24.75 | 16.75 | 67.97 | 91.16 | 13.22 | 35.68 |
| | water | wt % | | | | | | | | |
| | | Malic | | | | | | | | |
| | | acid | | | | | | | | |
| wheat | water | 0.5 | 140° C., 1 h | 55.14 | 17.44 | 22.95 | 65.13 | 99.95 | 41.34 | 21.25 |
| straw | | wt % | | | | | | | | |
| | | H₂SO₄ | | | | | | | | |
| | water | 3 wt % | 140° C., 1 h | 45.52 | 24.35 | 19.56 | 71.19 | 94.67 | 10.60 | 26.64 |
| | | acetic | | | | | | | | |
| | | acid | | | | | | | | |
| | water | 1.5 | 140° C., 1 h | 51.55 | 8.68 | 24.10 | 59.35 | 89.31 | 73.38 | 24.70 |
| | | wt % | | | | | | | | |
| | | AlCl₃ | | | | | | | | |
| | DES-1 + | None | 140° C., 1 h | 42.41 | 24.86 | 19.40 | 80.45 | 99.70 | 3.14 | 17.79 |
| | water | | | | | | | | | |
| | DES-1 + | 0.5 | 140° C., 1 h | 60.03 | 16.01 | 21.15 | 52.05 | 91.25 | 56.96 | 42.06 |
| | water | wt % | | | | | | | | |
| | | H₂SO₄ | | | | | | | | |
| | DES-1 + | 3 wt % | 140° C., 1 h | 43.45 | 24.02 | 19.37 | 71.94 | 91.37 | 10.85 | 26.58 |
| | water | acetic | | | | | | | | |
| | | acid | | | | | | | | |
| | DES-1 + | 1.5 | 140° C., 1 h | 66.27 | 8.38 | 15.90 | 46.44 | 90.46 | 79.82 | 60.89 |
| | water | wt % | | | | | | | | |
| | | AlCl₃ | | | | | | | | |
| | DES-2 + | 1.5 | 140° C., 1 h | 66.39 | 9.14 | 14.83 | 47.32 | 91.78 | 77.67 | 62.96 |
| | water | wt % | | | | | | | | |
| | | AlCl₃ | | | | | | | | |
| | DES-3 + | 1.5 | 140° C., 1 h | 61.36 | 8.44 | 17.50 | 49.18 | 88.19 | 78.57 | 54.67 |
| | water | wt % | | | | | | | | |
| | | AlCl₃ | | | | | | | | |
| Poplar | water | 0.5 | 140 C., 1 h | 65.64 | 10.07 | 25.10 | 69.54 | 96.42 | 59.94 | 22.59 |
| Wood | | wt % | | | | | | | | |
| | | H₂SO₄ | | | | | | | | |
| | water | 3 wt % | 140° C., 1 h | 55.18 | 19.06 | 22.29 | 87.91 | 98.48 | 4.18 | 13.14 |
| | | acetic | | | | | | | | |
| | | acid | | | | | | | | |
| | water | 1.5 | 140° C., 1 h | 60.11 | 10.18 | 24.62 | 78.67 | 99.81 | 53.95 | 14.19 |
| | | wt % | | | | | | | | |
| | | AlCl₃ | | | | | | | | |
| | DES-1 + | None | 140° C., 1 h | 53.40 | 19.54 | 23.36 | 87.21 | 98.37 | 2.56 | 9.65 |
| | water | | | | | | | | | |
| | DES-1 + | 0.5 | 140° C., 1 h | 75.27 | 9.42 | 19.55 | 60.45 | 95.94 | 67.54 | 47.67 |
| | water | wt % | | | | | | | | |
| | | H₂SO₄ | | | | | | | | |
| | DES-1 + | 3 wt % | 140° C., 1 h | 53.07 | 18.93 | 20.94 | 85.46 | 95.82 | 7.47 | 20.64 |
| | water | acetic | | | | | | | | |
| | | acid | | | | | | | | |
| | DES-1 + | 1.5 | 140° C., 1 h | 69.84 | 9.95 | 19.73 | 66.13 | 97.49 | 62.29 | 42.07 |
| | water | wt % | | | | | | | | |
| | | AlCl₃ | | | | | | | | |
| | DES-2 + | 1.5 | 140° C., 1 h | 70.95 | 10.22 | 19.19 | 67.58 | 99.24 | 60.47 | 42.45 |
| | water | wt % | | | | | | | | |
| | | AlCl₃ | | | | | | | | |
| | DES-3 + | 1.5 | 140° C., 1 h | 68.74 | 10.09 | 20.49 | 67.80 | 98.47 | 60.85 | 38.39 |
| | water | wt % | | | | | | | | |
| | | AlCl₃ | | | | | | | | |

### Example 3

TABLE 6 below shows the recovery rate and lignin content of solid residues after pretreatment and subsequent lignin removal from wheat straw and poplar wood in accordance with the exemplary method described above with reference to FIGS. 1 and 2. The results reflected in TABLE 6 were obtained utilizing: lignocellulosic biomasses presoaked in a ternary HDES overnight before reaction at high temperature. The HDESs tested included: thymol:2,6-dimethoxyphenol:o-anisic acid (2:2:1) (identified as “HDES 4” in TABLE 6); and thymol:2,6-dimethoxyphenol:decanoic acid (2:1:1) (indicated as “HDES 5” in TABLE 6). Lignocellulosic biomass to HDES ratio of 1:10 w/w; and an HDES to water of 1:1 w/w, under the conditions and with the use of the additives specified in TABLE 6. No acidic additive was utilized. The composition of the wheat straw prior to treatment with the HDESs (i.e., the raw biomass) was 34.21% cellulose, 19.38% hemicellulose, and 18.98% lignin. The composition of the poplar wood prior to treatment with the HDESs (i.e., the raw biomass) was 47.34% cellulose, 17.49% hemicellulose, and 22.55% lignin. Lignin content was determined in accordance with National Renewable Energy Laboratory (NREL) procedure for determining structural carbohydrate and lignin in biomass.⁶ Solid recovery, cellulose retention, and removal percentages calculated in same manner as in Example 2.

TABLE 6
Recovery rate and lignin content of solid residues after pretreatment with ternary
HDES and subsequent lignin removal from wheat straw and poplar wood.

| | | | | Solid residue | | | | | | |
|---|---|---|---|---|---|---|---|---|---|---|
| | | | | (Cellulose-rich | | | | | | |
| | | | | material) | | | Solid | | | |
| | | | Pretreatment | Cellulose | Hemicellulose | Lignin | recovery | Cellulose | Removal (%) | |
| Sample | Solvent | Additive | condition | (%) | (%) | (%) | (%) | retention(%) | Hemicellulose | Lignin |
| Wheat | DES- | N.A. | 140° C., 1 h | 56.44 | 15.12 | 18.51 | 60.44 | 99.71 | 50.28 | 37.87 |
| straw | 4 + | | | | | | | | | |
| | water | | | | | | | | | |
| | DES- | N.A. | 140° C., 1 h | 54.18 | 14.74 | 17.01 | 62.63 | 99.19 | 49.77 | 43.87 |
| | 5 + | | | | | | | | | |
| | water | | | | | | | | | |
| Poplar | DES- | N.A. | 140° C., 1 h | 51.11 | 14.58 | 23.88 | 67.12 | 100.27 | 46.76 | 15.55 |
| wood | 4 + | | | | | | | | | |
| | water | | | | | | | | | |
| | DES- | N.A. | 140° C., 1 h | 48.12 | 15.99 | 23.35 | 69.77 | 98.14 | 39.30 | 14.17 |
| | 5 + | | | | | | | | | |
| | water | | | | | | | | | |

The results shown in TABLE 6 suggest that 4-hydroxybenzoic acid and o-anisic acid present in the tested ternary HDESs were effective in promoting the cleavage of covalent bonds that link lignin with hemicellulose and cellulose and facilitated depolymerization of hemicellulose. Without wishing to be bound by any particular theory, it is believed that the use of butyric acid, dodecanoic acid, gallic acid, ferulic acid, vanillic acid, anisic acid, 3,4-dimethoxybenzoic acid, 3,4,5-trimethoxybenzoic acid, or toluic acid as the acidic compound of the ternary HDES would be similarly effective with respect to promoting the cleavage of covalent bonds linking lignin with hemicellulose and cellulose due to such acids possessing a carboxyl group that can release hydrogen ions.

All publications, patents, and patent applications mentioned in this specification are herein incorporated by reference to the same extent as if each individual publication, patent, or patent application was specifically and individually indicated to be incorporated by reference, including the references set forth in the following references list:

### REFERENCES

1. Tayyb, et al., Bioethanol Production From Lignocellulosic Biomass By Environment-Friendly Pretreatmetn Methods: A Review, Applied Ecology and Environmental Research (1): 225-249 (2018), DOI: http://dx.doi.org/10.15666/aeer/1601_225249.
2. U.S. Patent Application Publication No. 2022/0144669.
3. U.S. Patent Application Publication No. 2021/0301249.
4. U.S. Pat. No. 11,553,715.
5. U.S. Pat. No. 11,932,557.
6. Sluiter, et al., Determination of Structural Carbohydrates and Lignin in Biomass, Laboratory Analytical Procedure, Version Aug. 3, 2012 (Issue Date: April 2008; Revision Date: August 2012) available at https://www.nrel.gov/docs/gen/fy13/42618.pdf.
7. Fache, M., Boutevin, B., & Caillol, S. (2016). Vanillin production from lignin and its use as a renewable chemical. ACS sustainable chemistry & engineering, 4 (1), 35-46. DOI: 10.1021/acssuschemeng.5b01344.
8. Wendisch, V. F., Kim, Y., & Lee, J. H. (2018). Chemicals from lignin: recent depolymerization techniques and upgrading extended pathways. Current Opinion in Green and Sustainable Chemistry, 14, 33-39. DOI: 10.1016/j.cogsc.2018.05.006.
9. Zhang, Y., Qiao, Q., Abbas, U. L., Liu, J., Zheng. Y., Jones, C., . . . & Shi, J. (2023). Lignin derived hydrophobic deep eutectic solvents as sustainable extractants. Journal of Cleaner Production, 388, 135808. DOI: 10.1016/j.jclepro.2022.135808.
10. Qiao, Q., Shi, J., & Shao, Q. (2021). The multiscale solvation effect on the reactivity of β-O-4 of lignin dimers in deep eutectic solvents. Physical Chemistry Chemical Physics, 23 (45), 25699-25705. DOI: 10.1039/D1CP04342K.
11. Adney, B., Baker, J. 1996. Measurement of Cellulase Activities. Laboratory Analytical Procedure.
12. Ashokkumar, V., Venkatkarthick, R., Jayashree, S., Chuetor, S., Dharmaraj, S., Kumar, G., Chen, W. H., Ngamcharussrivichai, C. 2022. Recent advances in lignocellulosic biomass for biofuels and value-added bioproducts-A critical review. Bioresour Technol, 344 (Pt B), 126195.
13. Behera, S., Arora, R., Nandhagopal, N., Kumar, S. 2014. Importance of chemical pretreatment for bioconversion of lignocellulosic biomass. Renewable and Sustainable Energy Reviews, 36, 91-106.
14. Beig, B., Riaz, M., Raza Naqvi, S., Hassan, M., Zheng, Z., Karimi, K., Pugazhendhi, A., Atabani, A. E., Thuy Lan Chi, N. 2021. Current challenges and innovative developments in pretreatment of lignocellulosic residues for biofuel production: A review. Fuel, 287.
15. Bhatia, S. K., Jagtap, S. S., Bedekar, A. A., Bhatia, R. K., Patel, A. K., Pant, D., Rajesh Banu, J., Rao, C. V., Kim, Y. G., Yang, Y. H. 2020. Recent developments in pretreatment technologies on lignocellulosic biomass: Effect of key parameters, technological improvements, and challenges. Bioresour Technol, 300, 122724.
16. Cao, J., Su, E. 2021. Hydrophobic deep eutectic solvents: the new generation of green solvents for diversified and colorful applications in green chemistry. Journal of Cleaner Production, 314.
17. Chen, Z., Wang, Y., Cheng, H., Zhou, H. 2022. Hemicellulose degradation: An overlooked issue in acidic deep eutectic solvents pretreatment of lignocellulosic biomass. Industrial Crops and Products, 187.
18. Del Mar Contreras-Gamez, M., Galan-Martin, A., Seixas, N., da Costa Lopes, A. M., Silvestre, A., Castro, E. 2023. Deep eutectic solvents for improved biomass pretreatment: Current status and future prospective towards sustainable processes. Bioresour Technol, 369, 128396.
19. El Achkar, T., Greige-Gerges, H., Fourmentin, S. 2021. Basics and properties of deep eutectic solvents: a review. Environmental Chemistry Letters, 19 (4), 3397-3408.
20. Guerra, A., Filpponen, I., Lucia, L. A., Argyropoulos, D. S. 2006. Comparative evaluation of three lignin isolation protocols for various wood species. Journal of agricultural food chemistry, 54 (26), 9696-9705.
21. Hansen, B. B., Spittle, S., Chen, B., Poe, D., Zhang, Y., Klein, J. M., Horton, A., Adhikari, L., Zelovich, T., Doherty, B. W., Gurkan, B., Maginn, E. J., Ragauskas, A., Dadmun, M., Zawodzinski, T. A., Baker, G. A., Tuckerman, M. E., Savinell, R. F., Sangoro, J. R. 2021. Deep Eutectic Solvents: A Review of Fundamentals and Applications. Chem Rev, 121 (3), 1232-1285.
22. Isci, A., Kaltschmitt, M. 2021. Recovery and recycling of deep eutectic solvents in biomass conversions: a review. Biomass Conversion and Biorefinery, 12 (S1), 197-226.
23. Jose, D., Tawai, A., Divakaran, D., Bhattacharyya, D., Venkatachalam, P., Tantayotai, P., Sriariyanun, M. 2023. Integration of deep eutectic solvent in biorefining process of lignocellulosic biomass valorization. Bioresource Technology Reports, 21.
24. Li, P., Yang, C., Jiang, Z., Jin, Y., Wu, W. 2023. Lignocellulose pretreatment by deep eutectic solvents and related technologies: A review. Journal of Bioresources and Bioproducts, 8 (1), 33-44.
25. Lin, W., Xing, S., Jin, Y., Lu, X., Huang, C., Yong, Q. 2020. Insight into understanding the performance of deep eutectic solvent pretreatment on improving enzymatic digestibility of bamboo residues. Bioresour Technol, 306, 123163.
26. Lobato-Peralta, D. R., Duque-Brito, E., Villafán-Vidales, H. I., Longoria, A., Sebastian, P. J., Cuentas-Gallegos, A. K., Arancibia-Bulnes, C. A., Okoye, P. U. 2021. A review on trends in lignin extraction and valorization of lignocellulosic biomass for energy applications. Journal of Cleaner Production, 293.
27. Lobato-Rodriguez, A., Gullon, B., Romani, A., Ferreira-Santos, P., Garrote, G., Del-Rio, P. G. 2023. Recent advances in biorefineries based on lignin extraction using deep eutectic solvents: A review. Bioresour Technol, 388, 129744.
28. Mankar, A. R., Pandey, A., Modak, A., Pant, K. K. 2021. Pretreatment of lignocellulosic biomass: A review on recent advances. Bioresour Technol, 334, 125235.
29. Rezania, S., Oryani, B., Cho, J., Talaiekhozani, A., Sabbagh, F., Hashemi, B., Rupani, P. F., Mohammadi, A. A. 2020. Different pretreatment technologies of lignocellulosic biomass for bioethanol production: An overview. Energy, 199.
30. Segal, L., Creely, J. J., Martin Jr, A., Conrad, C. 1959. An empirical method for estimating the degree of crystallinity of native cellulose using the X-ray diffractometer. Textile research journal, 29 (10), 786-794.
31. Selig, M., Weiss, N., Ji, Y. 2008. Enzymatic saccharification of lignocellulosic biomass. laboratory analytical procedure.
32. Sharma, V., Tsai, M. L., Chen, C. W., Sun, P. P., Patel, A. K., Singhania, R. R., Nargotra, P., Dong, C. D. 2022. Deep eutectic solvents as promising pretreatment agents for sustainable lignocellulosic biorefineries: A review. Bioresour Technol, 360, 127631.
33. Shen, X.-J., Wen, J.-L., Mei, Q.-Q., Chen, X., Sun, D., Yuan, T.-Q., Sun, R.-C. 2019. Facile fractionation of lignocelluloses by biomass-derived deep eutectic solvent (DES) pretreatment for cellulose enzymatic hydrolysis and lignin valorization. Green Chemistry, 21 (2), 275-283.
34. Sluiter, A., Hames, B., Ruiz, R., Scarlata, C., Sluiter, J., Templeton, D. 2006. Determination of sugars, byproducts, and degradation products in liquid fraction process samples. Laboratory analytical procedure, 11, 65-71.
35. Sluiter, A., Hames, B., Ruiz, R., Scarlata, C., Sluiter, J., Templeton, D., Crocker, D. 2008. Determination of structural carbohydrates and lignin in biomass. Laboratory analytical procedure, 1617 (1), 1-16.
36. Song, Y., Chandra, R. P., Zhang, X., Tan, T., Saddler, Jack N. 2019. Comparing a deep eutectic solvent (DES) to a hydrotrope for their ability to enhance the fractionation and enzymatic hydrolysis of willow and corn stover. Sustainable Energy & Fuels, 3 (5), 1329-1337.
37. Tursi, A. 2019. A review on biomass: importance, chemistry, classification, and conversion. Biofuel Research Journal, 6 (2), 962-979.
38. Ullah, A., Zhang, Y., Liu, C., Qiao, Q., Shao, Q., Shi, J. 2023. Process intensification strategies for green solvent mediated biomass pretreatment. Bioresour Technol, 369, 128394.
39. Velvizhi, G., Balakumar, K., Shetti, N. P., Ahmad, E., Kishore Pant, K., Aminabhavi, T. M. 2022. Integrated biorefinery processes for conversion of lignocellulosic biomass to value added materials: Paving a path towards circular economy. Bioresour Technol, 343, 126151.
40. Wu, S., Argyropoulos, D. 2003. An improved method for Isolating lignin in high yield and purity. J Pulp Pap Sci, 29 (7), 235-240.
41. Zainal-Abidin, M. H., Hayyan, M., Wong, W. F. 2021. Hydrophobic deep eutectic solvents: Current progress and future directions. Journal of Industrial and Engineering Chemistry, 97, 142-162.
42. Zhang, Y., Qiao, Q., Abbas, U. L., Liu, J., Zheng, Y., Jones, C., Shao, Q., Shi, J. 2023. Lignin derived hydrophobic deep eutectic solvents as sustainable extractants. Journal of Cleaner Production, 388.
43. Zhao, L., Sun, Z. F., Zhang, C. C., Nan, J., Ren, N. Q., Lee, D. J., Chen, C. 2022. Advances in pretreatment of lignocellulosic biomass for bioenergy production: Challenges and perspectives. Bioresour Technol, 343, 126123.
44. Zhao, X., Zhang, L., Liu, D. 2012. Biomass recalcitrance. Part I: the chemical compositions and physical structures affecting the enzymatic hydrolysis of lignocellulose. Biofuels, Bioproducts and Biorefining, 6 (4), 465-482.
45. Tan, Y. T., Chua, A. S. M., & Ngoh, G. C. (2020). Deep eutectic solvent for lignocellulosic biomass fractionation and the subsequent conversion to bio-based products-A review. Bioresource Technology, 297, 122522.
46. Ullah, A., Zhang, Y., Liu, C., Qiao, Q., Shao, Q., Shi, J. 2023. Process intensification strategies for green solvent mediated biomass pretreatment. Bioresour Technol, 369, 128394.
47. Solarte-Toro, J. C., Romero-García, J. M., Martínez-Patiño, J. C., Ruiz-Ramos, E., Castro-Galiano, E., & Cardona-Alzate, C. A. (2019). Acid pretreatment of lignocellulosic biomass for energy vectors production: a review focused on operational conditions and techno-economic assessment for bioethanol production. Renewable and Sustainable Energy Reviews, 107, 587-601.
48. Xu, et al., Key process parameters for deep eutectic solvents pretreatment of lignocellulosic biomass materials: A review. Bioresource technology. 310, 123416 (2020).
49. Yoo, C. G., Meng, X., Pu, Y., & Ragauskas, A. J. (2020). The critical role of lignin in lignocellulosic biomass conversion and recent pretreatment strategies: A comprehensive review. Bioresource technology, 301, 122784.
50. Wojciechowski, et al., Lignocellulosic biomass: Acid and alkaline pretreatments and their effects on biomass recalcitrance-Conventional processing and recent advances. Bioresource technology, 304, 122848 (2020).
51. Fougere, D., Nanda, S., Clarke, K., Kozinski, J. A., & Li. K. (2016). Effect of acidic pretreatment on the chemistry and distribution of lignin in aspen wood and wheat straw substrates. Biomass and Bioenergy, 91, 56-68.
52. Donohoe, B. S., Decker, S. R., Tucker, M. P., Himmel, M. E., & Vinzant, T. B. (2008). Visualizing lignin coalescence and migration through maize cell walls following thermochemical pretreatment. Biotechnology and bioengineering, 101 (5), 913-925.
53. Tang, W., Wu, X., Huang, C., Huang, C., Lai, C., & Yong, Q. (2019). Enhancing enzymatic digestibility of waste wheat straw by presoaking to reduce the ash-influencing effect on autohydrolysis. Biotechnology for biofuels, 12, 1-11.
54. Tang, W., Wu, X., Huang, C., Ling, Z., Lai, C., & Yong, Q. (2021). Revealing the influence of metallic chlorides pretreatment on chemical structures of lignin and enzymatic hydrolysis of waste wheat straw. Bioresource Technology, 342, 125983.
55. Álvarez, C., Reyes-Sosa, F. M., & Díez, B. (2016). Enzymatic hydrolysis of biomass from wood. Microbial biotechnology, 9 (2), 149-156.
56. Yin, X., Cai, T., Liu, C., Huang, C., Wang, J., Hu, J., . . . & Wang, K. (2022). A mild biomass pretreatment process with efficiency and specificity in co-solvent of γ-valerolactone and aqueous p-toluenesulfonic acid. Chemical Engineering Journal, 437, 135408.
57. Lyu, Q., Chen, X., Zhang, Y., Yu, H., Han, L., & Xiao, W. (2021). One-pot fractionation of corn stover with peracetic acid and maleic acid. Bioresource Technology, 320, 124306.
58. Liu, E., Das, L., Zhao, B., Crocker, M., & Shi, J. (2017). Impact of dilute sulfuric acid, ammonium hydroxide, and ionic liquid pretreatments on the fractionation and characterization of engineered switchgrass. Bioenergy Research, 10, 1079-1093.
59. Li, M., Pu, Y., & Ragauskas, A. J. (2016). Current understanding of the correlation of lignin structure with biomass recalcitrance. Frontiers in chemistry, 4, 45.
60. Vermaas, J. V., Petridis, L., Qi, X., Schulz, R., Lindner, B., & Smith, J. C. (2015). Mechanism of lignin inhibition of enzymatic biomass deconstruction. Biotechnology for biofuels, 8, 1-16.
61. Dulie, N. W., Woldeyes, B., Demsash, H. D., & Jabasingh, A. S. (2021). An insight into the valorization of hemicellulose fraction of biomass into furfural: catalytic conversion and product separation. Waste and Biomass Valorization, 12, 531-552.
62. Xing. R., Qi, W., & Huber, G. W. (2011). Production of furfural and carboxylic acids from waste aqueous hemicellulose solutions from the pulp and paper and cellulosic ethanol industries. Energy & Environmental Science, 4 (6), 2193-2205.
63. Lyu, Q., Chen, X., Li, W., Zhang, Y., Xiao, A., Chen, J., . . . & Xiao, W. (2022). A multi-product strategy for the fractionation of corn stover based on peracetic acid and maleic acid processing. Journal of Environmental Chemical Engineering, 10 (6), 108764.
64. Liu, E., Li, M., Das, L., Pu, Y., Frazier, T., Zhao, B., . . . & Shi, J. (2018). Understanding lignin fractionation and characterization from engineered switchgrass treated by an aqueous ionic liquid. ACS Sustainable Chemistry & Engineering, 6 (5), 6612-6623.
65. Ma, Q., Li, Z., Guo, L., Zhai, H., & Ren, H. (2021). Formation of high carbohydrate and acylation condensed lignin from formic acid-acetic acid-H2O biorefinery of corn stalk rind. Industrial Crops and Products, 161, 113165.
66. Zhong, et al., Pretreatment of willow using the alkaline-catalyzed sulfolane/water solution for high-purity and antioxidative lignin production. International journal of biological macromolecules, 159, 287-294 (2020).

It will be understood that various details of the presently disclosed subject matter can be changed without departing from the scope of the subject matter disclosed herein. Furthermore, the foregoing description is for the purpose of illustration only, and not for the purpose of limitation.

What is claimed is:

1. A method for processing a lignocellulosic biomass, comprising:
combining the lignocellulosic biomass with a hydrophobic deep eutectic solvent (HDES) and water;
heating a mixture including the lignocellulosic biomass, the HDES, and the water at a predetermined temperature for a predetermined period of time; and
separating the mixture into (i) a HDES phase, the HDES phase including the HDES and a first constituent of the lignocellulosic biomass, (ii) an aqueous phase including the water and a second constituent of the lignocellulosic biomass, and (iii) a solid-residue phase including a third constituent of the lignocellulosic biomass.

2. The method of claim 1, wherein separating the mixture comprises:
filtering the mixture to isolate a liquid fraction and a solid fraction, wherein the liquid fraction includes the HDES phase and the aqueous phase, and the solid fraction includes the solid-residue phase; and
centrifuging the liquid fraction to separate the HDES phase and the aqueous phase in the liquid fraction; and
isolating the HDES phase from the aqueous phase.

3. The method of claim 1, wherein separating the mixture comprises allowing, following the predetermined period of time, time for the mixture to separate into the HDES phase, the aqueous phase, and the solid-residue phase as a result of the hydrophobicity of the HDES phase and the density of the solid-residue phase.

4. The method of claim 1, wherein the mixture further includes an acidic additive or a basic additive.

5. The method of claim 1, wherein the mixture further includes an acidic additive selected from the group consisting of malic acid, acetic acid, sulfuric acid, and aluminum chloride.

6. The method of claim 5, wherein the acidic additive is 0.5 wt % to 3.0 wt % of the mixture.

7. The method of claim 1, and further comprising steps of:
precipitating the first constituent of the lignocellulosic biomass in the HDES phase by adding an anti-solvent to the HDES phase; and
isolating the first constituent precipitate of the lignocellulosic biomass from the HDES.

8. The method of claim 7, and further comprising steps of:
isolating the HDES from the anti-solvent; and
combining the isolated HDES with a second lignocellulosic biomass.

9. The method of claim 7, wherein the anti-solvent is selected from the group consisting of n-hexane, dimethyl ether, methyl acetate, and ethyl acetate.

10. The method of claim 1, wherein the first constituent is lignin, the second constituent is a hemicellulose or a derivative thereof, and the third constituent is a glucan.

11. The method of claim 1, wherein the HDES is selected from the group consisting of: menthol: 2,6-dimethoxyphenol (1:1); menthol: 2,6-dimethoxyphenol (1:2); menthol: 2,6-dimethoxyphenol (2:1); menthol:phenol (1:1); menthol:phenol (1:2); menthol:phenol (2:1); menthol: 1-phenylethanol (1:1); menthol:guaiacol (1:1); thymol:vanillin (1:1); thymol:2,6-dimethoxyphenol (1:1); thymol:2,6-dimethoxyphenol (1:2); thymol:2,6-dimethoxyphenol (2:1); thymol:phenol (1:1); thymol:phenol (1:2); thymol:phenol (2:1); decanoic acid:2,6-dimethoxyphenol (1:1); decanoic acid:2,6-dimethoxyphenol (1:2); decanoic acid:2,6-dimethoxyphenol (2:1); decanoic acid:phenol (1:1); decanoic acid:phenol (1:2); decanoic acid:phenol (2:1); decanoic acid:guaiacol (1:1); decanoic acid: 1-phenylethanol (1:1); 2,6-dimethoxyphenol:4-hydroxybenzyl alcohol (1:1); 2,6-dimethoxyphenol:4-hydroxybenzyl alcohol (2:1); 2,6-dimethoxyphenol:4-hydroxybenzyl alcohol (3:1); 2,6-dimethoxyphenol:4-hydroxybenzyl alcohol (4:1); 2,6-dimethoxyphenol:4-hydroxybenzyl alcohol (5:1); 2,6-dimethoxyphenol:vanillin (1:1); 2,6-dimethoxyphenol:vanillin (2:1); 2,6-dimethoxyphenol:phenol (1:1); 2,6-dimethoxyphenol:phenol (1:2); 2,6-dimethoxyphenol:phenol (2:1); thymol:2,6-dimethoxyphenol:o-anisic acid (2:2:1); thymol:2,6-dimethoxyphenol:decanoic acid (2:1:1); thymol:2,6-dimethoxyphenol:syringic acid (5:5:1); and thymol:2,6-dimethoxyphenol:vanillic acid (5:5:1).

12. The method of claim 1, wherein the HDES includes thymol and 2,6-dimethoxyphenol.

13. The method of claim 12, wherein the HDES is selected from the group consisting of: thymol:2,6-dimethoxyphenol (1:1); thymol:2,6-dimethoxyphenol (1:2); thymol:2,6-dimethoxyphenol (2:1); thymol:2,6-dimethoxyphenol:o-anisic acid (2:2:1); and thymol:2,6-dimethoxyphenol:decanoic acid (2:1:1).

14. The method of claim 1, wherein the lignocellulosic biomass is poplar wood.

15. The method of claim 1, wherein the lignocellulosic biomass is wheat straw.

16. The method of claim 1, wherein the predetermined period of time is at least one hour and the predetermined temperature is 120° C. to 140° C.

17. A method for processing a lignocellulosic biomass, comprising:
combining the lignocellulosic biomass with a hydrophobic deep eutectic solvent (HDES);
heating a mixture including the lignocellulosic biomass and the HDES at a predetermined temperature for a predetermined period of time;
adding water to the mixture after the predetermined period of time; and
separating the mixture, following the addition of water, into (i) a HDES phase, the HDES phase including the HDES and a first constituent of the lignocellulosic biomass, (ii) an aqueous phase including the water and a second constituent of the lignocellulosic biomass, and (iii) a solid-residue phase including a third constituent of the lignocellulosic biomass.

18. A method for processing a lignocellulosic biomass, comprising:
combining the lignocellulosic biomass with a hydrophobic deep eutectic solvent (HDES), water, and an acidic additive to form a mixture;
heating the mixture, after a first predetermined period of time following formation of the mixture, for a second predetermined period of time; and
separating the mixture into (i) a HDES phase, the HDES phase including the HDES and lignin, (ii) an aqueous phase including the water and a hemicellulose or a derivative thereof, and (iii) a solid-residue phase including a glucan.

19. The method of claim 18, wherein the acidic additive is selected from the group consisting of: malic acid, acetic acid, sulfuric acid, and aluminum chloride.

20. The method of claim 18, wherein the acidic additive is aluminum chloride and the HDES includes thymol and 2,6-dimethoxyphenol.

21. The method of claim 20, wherein the first predetermined period of time and the second predetermined period of time are each at least one hour; and wherein the predetermined temperature is 120° C. to 140° C.
